(19) United States
(12) Patent Application Publication
(10) Pub. No.: US 2023/0060872 A1
(43) Pub. Date: Mar. 2, 2023

(54) SURFACE-MODIFIED ELECTRODES, PREPARATION METHODS AND USES IN ELECTROCHEMICAL CELLS

(71) Applicant: HYDRO-QUÉBEC, Montréal (CA)

(72) Inventors: Nicolas DELAPORTE, Montréal (CA); Gilles LAJOIE, Varennes (CA); Steve COLLIN-MARTIN, Saint-Hubert (CA); Ali DARWICHE, LeMoyne (CA); Chisu KIM, Longueuil (CA); Karim ZAGHIB, Longueuil (CA); Daniel CLÉMENT, Saint-François-du-Lac (CA); Marie-Josée VIGEANT, Sorel-Tracy (CA)

(73) Assignee: HYDRO-QUÉBEC, Montréal, QC (CA)

(21) Appl. No.: 17/760,011

(22) PCT Filed: Feb. 12, 2021
(86) PCT No.: PCT/CA2021/050150

§ 371 Date: Aug. 3, 2022

(30) Foreign Application Priority Data
Feb. 14, 2020 (CA) 3,072,784

(51) Int. Cl. H01M 4/38; H01M 10/0525; H01M 10/0568; H01M 10/0569; H01M 4/36; H01M 4/60; H01M 4/48

(52) U.S. Cl. CPC H01M 4/382; H01M 4/48; H01M 4/366; H01M 4/602; H01M 10/0525; H01M 10/0568; H01M 10/0569; H01M 2004/021

(57) ABSTRACT

The present technology relates to the modification of the surface of an electrode comprising a thin layer, for example of 10 microns or less, of an inorganic compound (such as a ceramic) in a solid polymer, the inorganic compound being present in the thin layer at a concentration between about 40% and about 90% by weight. Also described are electrodes comprising the modified film, a component comprising the electrode and a solid electrolyte, and the electrochemical cells and accumulators comprising same.

### RELATED APPLICATION

The present application claims priority, under applicable law, from Canadian Patent Application Number 3,072,784 filed on Feb. 14, 2020, the content of which being incorporated herein by reference in its entirety and for all purposes.

### TECHNICAL FIELD

This application relates to lithium electrodes having at least one modified surface, to processes for their manufacture and to electrochemical cells comprising them.

### TECHNICAL BACKGROUND

Liquid electrolytes used in lithium-ion batteries are flammable and get slowly degraded to form a passivation layer at the surface of the lithium film or at the interface of the solid electrolyte (SEI for « solid electrolyte interface » or « solid electrolyte interphase ») irreversibly consuming lithium, which reduces the coulombic efficiency of the battery. In addition, lithium anodes undergo significant morphological changes during battery cycling and lithium dendrites are formed. As these usually migrate through the electrolyte, they can eventually cause short circuits. Safety concerns and the requirement for higher energy density have spurred research into the development of an all-solid-state lithium rechargeable battery with either a polymer or ceramic electrolyte, both of which being more stable to lithium metal and reducing lithium dendrite growth. Loss of reactivity and poor contact between solid interfaces in these all-solid-state batteries remain a problem, however.

A simple and more industrially applicable method for protecting the lithium surface is to coat its surface with a polymer or a polymer/lithium salt mixture by spraying, dipping, centrifuging or using the so-called doctor blade method (N. Delaporte, et al., Front. Mater., 2019, 6, 267). The selected polymer must be stable to lithium and an ionic conductor at low temperature. In a way, the polymer layer deposited on the lithium surface should be comparable to the solid polymer electrolytes (SPE) generally reported in the literature, which have a low glass transition (T_{g}) in order to remain rubbery at room temperature and to maintain a lithium conductivity similar to that of a liquid electrolyte. To accommodate the deformation of lithium during cycling and, especially to avoid the formation of lithium dendrites, the polymer must have good flexibility and must be characterized by a high Young modulus.

A few examples of polymers used in this type of protecting layer include polyacrylic acid (PAA) (N.-W. Li, et al., Angew. Chem. Int. Ed., 2018, 57, 1505-1509), poly(vinylidene carbonate-co-acrylonitrile) (S. M. Choi et al., J. Power Sources, 2013, 244, 363-368), polyethylene glycol) dimethacrylate (Y. M. Lee, et al., J. Power Sources, 2003, 119-121, 964-972), the PEDOT-co-PEG copolymer (G. Ma, et al., J. Mater. Chem. A, 2014, 2, 19355-19359 and I. S. Kang, et al., J. Electrochem. Soc., 2014, 161 (1), A53-A57), the polymer resulting from the direct polymerization of acetylene on lithium (D. G. Belov, et al., Synth. Met., 2006, 156, 745-751), in situ polymerized ethyl α-cyanoacrylate (Z. Hu, et al., Chem. Mater., 2017, 29, 4682-4689), and a polymer formed from the copolymer Kynar™ 2801 and the curable monomer 1,6-hexanediol diacrylate (N.-S. Choi, et al., Solid State Ion., 2004, 172, 19-24). The latter group also studied the incorporation of an ionic receptor into the polymer mixture (N.-S. Choi, et al., Electrochem. Commun., 2004, 6, 1238-1242).

Some studies have been performed on the incorporation of solid fillers, typically ceramics, into a polymer for lithium surface modification. For example, inorganic fillers (e.g., Al₂O₃, TiO₂, BaTiO₃) have been mixed with a polymer to give a hybrid organic-inorganic composite electrolyte.

A mixture of freshly synthesized spherical Cu₃N particles less than 100 nm in size and a styrene butadiene rubber (SBR) copolymer was applied by doctor blade on the lithium surface (Y. Liu, et al., Adv. Mater., 2017, 29, 1605531). Upon contact with lithium, Cu₃N is converted to highly lithium-conductive Li₃N. Li₄Ti₅O₁₂/Li (LTO/Li) cells were assembled with a liquid electrolyte and better electrochemical performance was obtained using lithium protected by a mixture of Cu₃N and SBR.

A 20 µm protective layer composed of Al₂O₃ particles (1.7 µm average diameter) and polyvinylidene fluoride-hexafluoropropylene (PVDF-HFP) deposited on the lithium surface has been proposed to improve the lifetime of lithium-oxygen batteries (D.J. Lee, et al., Electrochem. Commun., 2014, 40, 45-48). Co₃O₄-Super P/Li batteries with this protective layer and a liquid electrolyte. The effect of similarly modified lithium has also been studied by Gao and colleagues (H.K. Jing et al., J. Mater. Chem. A, 2015, 3, 12213-12219), although the focus has been on improving lithium-sulfur batteries. In this example, 100 nm Al₂O₃ spheres were used with PVDF as a binder and the mixture prepared in DMF solvent was spin-coated onto a lithium foil. Battery assembly was then performed with a liquid electrolyte.

A 25 µm porous layer of polyimide with Al₂O₃ as filler (particles size of about 10 nm) in order to limit the growth of lithium was also proposed (see Z. Peng et al., J. Mater. Chem. A, 2016, 4, 2427-2432). This method includes the formation of a film called “skin layer” by contacting lithium with an additive present in the liquid electrolyte (such as fluoroethylene carbonate (FEC), vinylene carbonate (VC) or hexamethylene diisocyanate (HDI)). Cu/LiFePO₄ electrochemical cells comprising this liquid electrolyte were tested to demonstrate the utility of the polyimide/Al₂O₃ layer in inhibiting dendrite formation and electrolyte degradation.

The protective layers described in the three previous paragraphs are porous and suitable for use with a liquid electrolyte, which can penetrate them. This type of layer is therefore not suitable for use with a solid electrolyte, which must be able to be in intimate contact with the surface of the electrode (or its protective layer) and allow the conduction of ions from the electrolyte to the active electrode material.

### SUMMARY

According to a first aspect, the present technology relates to an electrode comprising a metallic film modified by a thin layer, wherein:
the metallic film comprises lithium or an alloy comprising lithium, the metallic film comprising a first and a second surfaces; and
the thin layer comprises an inorganic compound in a solvating polymer (e.g., a solid polymer and/or a crosslinked polymer), the thin layer being disposed on the first surface of the metallic film and having an average thickness of about 10 µm or less (or between about 0.5 µm and about 10 µm, or about 1 µm and about 10 µm , or about 2 µm and about 8 µm , or between about 2 µm and about 7 µm, or between 2 µm and about 5 µm), the inorganic compound being present in the thin layer at a concentration between about 40% and about 90% by weight.

In one embodiment, the metallic film comprises lithium comprising less than 1000 ppm (or less than 0.1 wt.%) of impurities. In another embodiment, the metallic film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g., Zr, Cu, Ag, Bi, Co, Zn, Al, Si, Sn, Sb, Cd, Hg, Pb, Mn, B, In, Tl, Ni, or Ge). For example, the alloy comprises at least 75 wt.% lithium, or between 85% and 99.9 wt.% lithium.

According to another embodiment, the metallic film further comprises a passivation layer on the first surface, the first surface being in contact with the thin layer, for example, the passivation layer comprising a compound selected from a silane, a phosphonate, a borate or an inorganic compound (such as LiF, Li₃N, Li₃P, LiNO₃, Li₃PO₄).

In another embodiment, the first surface of the metallic film is modified by stamping beforehand.

In one embodiment, which the inorganic compound is in the form of particles (e.g., spherical, rod-like, needle-like, etc.). In another embodiment, the average particle size is less than 1 µm, less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or again between 50 nm and 200 nm, or between 100 nm and 200 nm, or between 1 nm and 100 nm, or between 10 nm and 100 nm, or again between 25 nm and 100 nm, or between 50 nm and 100 nm.

According to one embodiment, the inorganic compound comprises a ceramic.

According to another embodiment, the inorganic compound is selected from Al₂O₃, Mg\2B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., of aluminosilicate, of mesoporous silica), sulfide ceramics (such as Li₇P₃S₁₁), glass ceramics (such as LIPON, etc.), and other ceramics, as well as their combinations.

In yet another embodiment, the inorganic compound particles further comprise organic groups covalently grafted to their surface, for example, said groups being selected from crosslinkable groups (such as organic groups comprising an acrylate function, a methacrylate function, a vinyl function, a glycidyl function, a mercapto function, etc.), aryl groups, alkylene oxide or poly(alkylene oxide) groups, and other organic groups.

In one embodiment, the particles of the inorganic compound have a small specific surface area (e.g., less than 80 m²/g, or less than 40 m²/g) and, preferably, the inorganic compound is present in the thin layer at a concentration between about 65 wt.% and about 90 wt.%, or between about 70 wt.% and about 85 wt.%.

Alternatively, the particles of the inorganic compound have a large specific surface area (e.g., of 80 m²/g and above, or of 120 m²/g and above) and, preferably, the inorganic compound is present in the thin layer at a concentration between about 40 wt.% and about 65 wt.%, or between about 45 wt.% and about 55 wt.%.

According to another embodiment, the solvating polymer is selected from linear or branched polyether polymers (e.g., PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, optionally comprising crosslinked units derived from crosslinkable functions (such as acrylate function, methacrylate function, vinyl function, glycidyl function, mercapto function, etc.).

In another embodiment, the thin layer further comprises a lithium salt, for example selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(CeO₂)₂] (LBBB), and a combination thereof.

According to another embodiment, the electrode further comprises a current collector in contact with the second surface of the metallic film.

Another aspect relates to an electrode comprising an electrode material film modified by a thin layer, wherein:
the electrode material film comprises an electrochemically active material, optionally a binder, and optionally an electronically conductive material, the electrode material film comprising a first and a second surface; and
the thin layer comprises an inorganic compound in a solvating polymer (e.g., a solid polymer and/or a crosslinked polymer), the thin layer being disposed on the first surface of the metallic film and having an average thickness of about 10 µm (or between about 0.5 µm and about 10 µm, or between about 1 µm and about 10 µm , or between about 2 µm and about 8 µm, or between about 2 µm and about 7 µm, or between 2 µm and about 5 µm) or less, the inorganic compound being present in the thin layer at a concentration of between about 40 wt.% and about 90 wt.%.

According to one embodiment, the elements (inorganic compound, polymer, and optionally a salt) of the thin layer defined in the embodiments of the preceding aspect are also contemplated.

In another embodiment, the electrode further comprises a current collector in contact with the second surface of the electrode material film.

According to another embodiment, the electrochemically active material is selected from metal phosphates, lithiated metal phosphates, metal oxides, and lithiated metal oxides. In another embodiment, the electrochemically active material is LiM’PO₄ where M′ is Fe, Ni, Mn, Co, or a combination thereof, LiV₃O₈, V₂O₅F, LiV₂O₅, LiMn₂O₄, LiM“O₂, where M” is Mn, Co, Ni, or a combination thereof (such as NMC, LiMnₓCo_{y}Ni_{z}O₂ with x+y+z = 1), Li(NiM”’)O₂ (where M‴ is Mn, Co, Al, Fe, Cr, Ti, Zr, or a combination thereof), elemental sulfur, elemental selenium, elemental iodine, iron(III) fluoride, copper(II) fluoride, lithium iodide, carbon-based active materials such as graphite, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other.

In yet another embodiment, the electrochemically active material is in the form of optionally coated particles (e.g., with a polymer, ceramic, carbon or a combination of two or more thereof).

According to another aspect, the present document describes an electrode-electrolyte component comprising an electrode as herein defined and a solid electrolyte. In one embodiment, the solid electrolyte comprises at least one solvating polymer and a lithium salt.

In one embodiment, the solvating polymer of the electrolyte is selected from linear or branched polyether polymers (e.g., PEO, PPO, or an EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked.

In another embodiment, the lithium salt of the electrolyte is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

An additional aspect of the present document relates to an electrochemical cell comprising a negative electrode, a positive electrode, and a solid electrolyte, wherein at least one of the negative electrode and the positive electrode is as described herein. In one embodiment, the negative electrode is as described herein. In another embodiment, the positive electrode is as described herein. Alternatively, the negative electrode and the positive electrode are as described herein. In one embodiment, the electrolyte is as defined above.

Finally, the present technology also includes an electrochemical accumulator (e.g., a lithium battery or a lithium-ion battery) comprising at least one electrochemical cell as described herein, as well as their use in portable devices (such as cell phones, cameras, tablets, or laptops), in electric or hybrid vehicles, or in renewable energy storage.

### BRIEF DESCRIPTION OF THE FIGURES

FIG. 1 shows a photograph of a cross-section of a piece of lithium having a thin ceramic layer (85% spherical Al₂O₃).

FIG. 2 shows scanning electron microscopy (SEM) images of a thin layer comprising 50% Mg₂B₂O₅ on a LiAl alloy (a) and its corresponding chemical mapping: (b) magnesium, (c) boron, (d) oxygen, (e) sulfur, (f) fluorine, and (g) carbon.

FIG. 3 shows SEM images of a thin layer comprising a ceramic (85% spherical Al₂O₃) on a LiMg alloy and showing a layer rich in ceramic, the other rich in polymer and ceramic.

FIG. 4 shows SEM images of a thin layer comprising 50% Al₂O₃ in the form of needles (a) on a LiAl alloy and its corresponding chemical mapping: (b) C, Al, O, S and electron distribution, (c) aluminum, (d) oxygen, and (e) carbon.

FIG. 5 shows SEM images of a SPE (about 15-20 µm) comprising a spherical Al₂O₃ ceramic (70 wt.%) on a LiAl alloy (top image) and the S, C, Al, O and electrons distribution (bottom image).

FIG. 6 shows SEM images of a SPE (about 10-15 µm) comprising a spherical Al₂O₃ ceramic (85 wt.%) on a LiAl alloy (top image) and the S, C, Al, O and electrons distribution (bottom image).

FIG. 7 shows SEM images of a symmetrical Li/SPE/Li cell made with standard unmodified Li ((a) and (b)) and its chemical mapping: (c) carbon, (d) oxygen, (e) fluorine, (f) lithium, (g) sulfur, and (h) aluminum (Al from the support behind the sample).

FIG. 8 shows (a) spectroscopic impedance measurements for 4 cells; (b) cycling stability results at a C/4 rate (charge and discharge) for two cells (including two C/24 formation cycles); and (c) resistance results at different applied currents (C/24 to 1C) for two independent cells, all cells being symmetric and assembled with standard pure lithium.

FIG. 9 shows (a) spectroscopic impedance measurements for 4 cells; (b) cycling stability results at a C/4 rate (charge and discharge) for two cells (including two C/24 formation cycles); and (c) resistance results at different applied currents (C/24 to 1C) for two independent cells, all cells being symmetrical and assembled with a LiAl lithium alloy.

FIG. 10 shows (a) spectroscopic impedance measurements for 4 cells; (b) cycling stability results at a C/4 rate (charge and discharge) for two cells (including two C/24 formation cycles); and (c) resistance results at different applied currents (C/24 to 1C) for two independent cells, all cells being symmetrical and assembled with a LiMg lithium alloy.

FIG. 11 presents SEM images of a symmetrical LiAl/SPE/LiAl cell assembled with standard Li modified with spherical Al₂O₃ (85 wt.%) at various magnifications.

FIG. 12 shows SEM images of a symmetrical LiAl/SPE/LiAl cell assembled with standard Li modified with spherical Al₂O₃ (85 wt.%) (in (a)) and its chemical mapping: (b) oxygen, (c) aluminum, (d) carbon, (e) fluorine, (f) sulfur, and (g) lithium.

FIG. 13 shows the results of (a) resistance at different applied currents (C/24 to 1C) for a battery assembled with two LiAl; (b) and (c) spectroscopic impedance measurements carried out at 50° C. for 2 batteries after assembly and after each cycling rate, all batteries being symmetrical with LiAl modified with spherical Al₂O₃ (85 wt.%).

FIG. 14 shows the results of (a) and (b) a cycling stability study at a 1C rate (charge and discharge) with a return to a C/4 rate for 3 cycles for two independent cells; (c) and (d) spectroscopic impedance measurements performed every three cycles at 50° C. for the same cells, all cells being symmetrical with LiAl modified with spherical Al₂O₃ (85 wt.%).

FIG. 15 shows SEM images of a symmetrical LiAl/SPE/LiAl cell prepared with standard Li modified with spherical Al₂O₃ (85 wt.%) (in (a)) and its chemical mapping: (b) oxygen, (c) carbon, (d) aluminum, (e) fluorine, (f) sulfur, and (g) lithium (symmetrical cell having short-circuited).

FIG. 16 presents (a) spectroscopic impedance measurements for 4 cells; (b) cycling stability results at a C/4 rate (charge and discharge) for two cells (including two C/24 formation cycles); and (c) resistance results at different applied currents (C/24 to 1C) for two independent cells, all cells being symmetrical and assembled with spherical Al₂O₃-modified lithium (85 wt.%).

FIG. 17 shows (a) spectroscopic impedance measurements for 3 cells; (b) cycling stability results at a C/4 rate (charge and discharge) for one cell (including two C/24 formation cycles); and (c) resistance results at different applied currents (C/24 to 1C) for two independent cells, all cells being symmetrical and assembled with needle Al₂O₃-modified lithium (50 wt.%).

FIG. 18 shows in (a) a scheme illustrating the configuration of cells assembled with needle Al₂O₃ modified LiAl (50 wt.%) on one side and unmodified LiAl on the other, and the results obtained with these cells including (b) spectroscopic impedance measurements for four cells; (c) cycling stability results at a C/4 regime (charge and discharge) for two cells (including two C/24 formation cycles); and (d) resistance results at different imposed currents (C/24 to 1C) for two independent cells.

FIG. 19 shows SEM images of a battery (not short-circuited) assembled with LiAl modified with needle-like Al₂O₃ (50 wt.%) on one side and unmodified LiAl on the other (in (a) and (b)) and its chemical mapping: (c) carbon, (d) oxygen, (e) aluminum, (f) fluorine, (g) sulfur, and (h) lithium.

FIG. 20 shows SEM images of a battery (short-circuited) assembled with LiAl modified with needle-like Al₂O₃ (50 wt.%) on one side and unmodified LiAl on the other (in (a), (b) and (c)) and its chemical mapping: (d) carbon, (e) oxygen, (f) fluorine, (g) aluminum, (h) sulfur, and (i) lithium.

FIG. 21 shows (a) a schematic illustration of a stack assembly where a LiAl film has an approximately 25 µm thick layer directly deposited on its surface containing 85% spherical Al₂O₃; (b) spectroscopic impedance measurements performed at 50° C. for 2 independent stacks; and (c) the first two C/24 formation cycles for two cells assembled according to the schematic representation in (a).

FIG. 22 presents the first two charge/discharge curves obtained at 80° C. and C/24 for LFP/SPE/LiAl batteries assembled with (a) an unmodified LiAl anode; (b) a LiAl anode with a layer comprising 50% needle-shaped Al₂O₃; and (c) a LiAl anode with a layer comprising 85% spherical Al₂O₃.

FIG. 23 shows galvanostatic cycling results obtained at 50° C. and C/6 (2 cycles at C/12 every 20 cycles at C/6) for LFP/SPE/LiAl batteries assembled with (a) an unmodified LiAl anode; (b) a LiAl anode with 50% needle-shaped Al₂O₃; and (c) a LiAl anode with a layer comprising 85% spherical Al₂O₃.

FIG. 24 presents galvanostatic cycling results obtained at 50° C. and C/6 (2 cycles at C/12 every 20 cycles at C/6) for LFP/SPE/LiMg batteries assembled with (a) an unmodified LiMg anode; and (b) a LiMg anode with a layer comprising 85% spherical Al₂O₃.

FIG. 25 presents galvanostatic cycling results obtained at 50° C. and C/6 (2 cycles at C/12 every 20 cycles at C/6) for LFP/SPE/Li batteries assembled with (a) an unmodified Li anode; and (b) a Li anode with a layer containing 85% spherical Al₂O₃.

FIG. 26 shows SEM images of a thin layer of a polymer and a salt (without ceramic) on a composite material comprising LiFePO₄ (x500 on the left and x5000 on the right).

FIG. 27 shows SEM images of a thin layer of a polymer and a salt (without ceramic) on a composite material comprising LiFePO₄ (in (a)) and its corresponding chemical mapping: (b) iron, (c) phosphorus, (d) oxygen, (e) carbon, and (f) sulfur.

FIG. 28 shows a SEM image of the edge of the LFP cathode with a polymer + salt (20:1 O:Li) thin layer containing 50 wt.% spherical Al₂O₃.

FIG. 29 shows SEM images of the edge of the LFP cathode with a polymer + salt (20:1 O:Li) thin layer containing 50 wt.% spherical Al₂O₃ (in (a)) and its corresponding chemical mapping of (b) phosphorus, (c) iron, (d) oxygen, (e) carbon, and (f) aluminum.

FIG. 30 presents the results of (a) long cycling (charge: C/6, discharge: C/3) and (b) cycling at different C rates at 80° C., for LFP/SPE/Li batteries assembled with a standard (unmodified) LiAl, a standard SPE (polymer+LiTFSI with a 30:1 O:Li ratio, 20 µm thickness) and a LFP cathode with (LFP overcoated) and without (LFP_REF) thin ceramic layer (50% Al₂O₃).

### DETAILED DESCRIPTION

All technical and scientific terms and expressions used herein have the same meaning as generally understood by the person skilled in the art of this technology. Definitions of some of the terms and expressions used are nonetheless provided hereinbelow.

When the term “about” is used here, it means approximately, in the region of, and around. When the term “about” is used in relation to a numerical value, it may modify it, for example, above and below its nominal value by a variation of 10%. This term can also take into account, for example, the experimental error specific to a measuring device or the rounding of a value.

When a range of values is referred to in this application, the lower and upper limits of the range are, unless otherwise specified, always included in the definition. For example, “between x and y”, or “from x to y” means a range in which the x and y limits are included unless otherwise specified. For example, the range “between 1 and 50” includes the values 1 and 50.

The chemical structures described herein are drawn according to the conventions of the field. Also, when an atom, such as a carbon atom, as drawn appears to include an incomplete valence, then it will be assumed that the valence is satisfied by one or more hydrogen atoms even if they are not explicitly drawn.

As used herein, the term “alkyl” refers to saturated hydrocarbon groups having from 1 to 20 carbon atoms, including linear or branched alkyl groups. Non-limiting examples of alkyls may include the groups methyl, ethyl, propyl, butyl, pentyl, hexyl, heptyl, octyl, nonyl, decyl, isopropyl, tert-butyl, sec-butyl, isobutyl and the like. Similarly, an “alkylene” group refers to an alkyl group located between two other groups. Examples of alkylene groups include methylene, ethylene, propylene, etc. The terms “C₁-Cₙalkyl” and “C₁-Cₙalkylene” refer to an alkyl or alkylene group having from 1 to “n” number of carbon atoms.

The present document therefore presents a process for surface modification of an electrode film. According to one example, this electrode film comprises a metallic film, for example comprising lithium or an alloy predominantly comprising lithium. According to another example, the electrode film comprises an electrochemically active material, optionally a binder, and optionally an electronically conducting material. By surface modification is meant the application of an ion-conducting thin layer that serves as a barrier to dendrite formation but does not substantially react with the surface of the electrode film, as the elements of the thin layer are mainly non-reactive.

The surface of the electrode film is modified by applying to one of its surfaces a thin layer comprising an inorganic compound in a solvating polymer, preferably a solid, optionally cross-linked polymer. The thin layer is disposed on the first surface of the metallic film and has an average thickness of about 10 µm or less. The inorganic compound is present in the thin layer at a concentration in the range of about 40 wt.% to about 90 wt.%.

The inorganic compound is preferably in the form of particles (e.g., spherical, rod-like, needle-like, etc.). The average particle size is preferably nanometric, for example, less than 1 µm, less than 500 nm, or less than 300 nm, or less than 200 nm, or between 1 nm and 500 nm, or between 10 nm and 500 nm, or again between 50 nm and 500 nm, or between 100 nm and 500 nm, or between 1 nm and 300 nm, or between 10 nm and 300 nm, or again between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or again between 25 nm and 100 nm, or between 50 nm and 100 nm.

Non-limiting examples of inorganic compounds include compounds or ceramics such as Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, y-LiAlO₂, molecular sieves and zeolites (e.g., of aluminosilicate, of mesoporous silica, etc.), sulfide ceramics (like Li₇P₃S₁₁), glass ceramics (such as LIPON, etc.), and other ceramics, as well as combinations thereof.

The surface of the inorganic compound particles may also be modified by organic groups covalently grafted to their surface. For example, the groups may be selected from crosslinkable groups, aryl groups, alkylene oxide or poly(alkylene oxide) groups, and other organic groups, these being grafted on the surface directly or via a linking group.

For example, the crosslinkable groups may include glycidyl, mercapto, vinyl, acrylate, or methacrylate functions. An example of a method for grafting silanes comprising propyl methacrylate moieties is presented in Scheme 1.

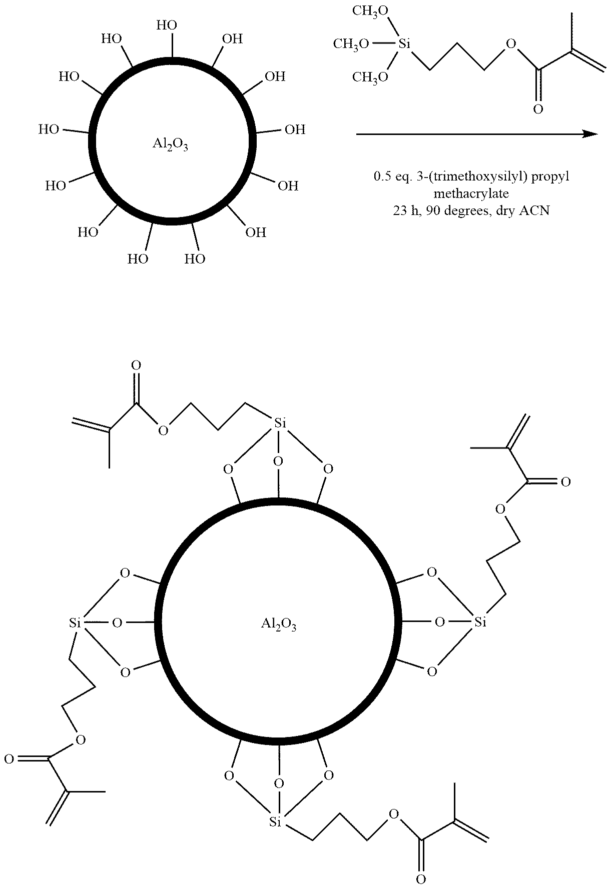

In some cases, the particles of the inorganic compound have a small specific surface area (for example, less than 80 m²/g, or less than 40 m²/g). The concentration of the inorganic compound in the thin layer may then be relatively high, for example, between about 65 wt.% and about 90 wt.%, or between about 70 wt.% and about 85 wt.%.

In other cases, the inorganic compound particles have a large specific surface area (e.g., 80 m²/g and above, or 120 m²/g and above). The greater porosity of the inorganic compound may then require a larger amount of polymer and the concentration of the inorganic compound in the thin layer may then be in the range of 40 wt.% to about 65 wt.%, or between about 45 wt.% and about 55 wt.%.

As described above, the average thickness of the thin layer is such that it is considered a modification of the electrode surface rather than an electrolyte layer. As mentioned above, the average thickness of the thin layer is less than 10 µm. For example, it is between about 0.5 µm and about 10 µm, or between about 1 µm and about 10 µm, or between about 2 µm and about 8 µm, or between about 2 µm and about 7 µm, or again between 2 µm and about 5 µm.

The polymer present in the layer is a crosslinked polymer comprising ion solvating units, in particular of lithium ions. Examples of solvating polymers include linear or branched polyether polymers (e.g., PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, and optionally comprising crosslinked units derived from crosslinkable functions (such as acrylate functions, methacrylate functions, vinyl functions, glycidyl functions, mercapto functions, etc.).

According to a preferred example, the thin layer further comprises a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), and/or lithium bis(1,2-benzenediolato(2-)-O,O′)borate Li[B(C₆O₂)₂] (LBBB).

As mentioned above, the electrode may comprise a metallic lithium film or an alloy comprising lithium, optionally on a current collector. When the metallic film is a lithium film, then it is composed of lithium comprising less than 1000 ppm (or less than 0.1 wt.%) of impurities. Alternatively, a lithium alloy may comprise at least 75 wt.% of lithium, or between 85 wt.% and 99.9 wt.% of lithium. The alloy may then comprise an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel, and germanium (e.g., Zr, Cu, Ag, Bi, Co, Zn, Al, Si, Sn, Sb, Cd, Hg, Pb, Mn, B, In, Tl, Ni, or Ge).

The metallic film may also include a passivation layer on the first surface, which is in contact with the thin layer. For example, the passivation layer comprises a compound selected from a silane, a phosphonate, a borate or an inorganic compound (such as LiF, Li₃N, Li₃P, LiNO₃, Li₃PO₄). For example, the passivation layer is formed on the metallic film before the thin layer is added.

The surface of the metallic film can also be treated before the application of the thin layer, for example by stamping.

As mentioned above, when the electrode is not a metallic film, the electrode comprises an electrochemically active material (e.g., of a positive electrode), optionally a binder, and optionally an electronically conductive material, optionally on a current collector. For instance, the electrochemically active material may be selected from metal phosphates, lithiated metal phosphates, metal oxides, and lithiated metal oxides, but also other materials such as elemental sulfur, selenium or iodine, iron(III) fluoride, copper(II) fluoride, lithium iodide, and carbon-based active materials such as graphite. Examples of electrochemically active material include LiM'PO₄ where M′ is Fe, Ni, Mn, Co, or a combination thereof, LiV₃O₈, V₂O₅F, LiV₂O₅, LiMn₂O₄, LiM”O₂, where M″ is Mn, Co, Ni, or a combination thereof (such as NMC, LiMnₓCo_{y}Ni_{z}O₂ with x+y+z = 1), Li(NiM"')O₂ (where M‴ is Mn, Co, Al, Fe, Cr, Ti, Zr, or a combination thereof), elemental sulfur, elemental selenium, elemental iodine, iron(III) fluoride, copper(II) fluoride, lithium iodide, carbon-based active materials such as graphite, organic cathode active materials such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone, or a combination of two or more of these materials if compatible with each other and with the counter electrode, for instance, a lithium electrode. The electrochemically active material is preferably in the form of particles that may optionally be coated with, for example, polymer, ceramic, carbon or a combination of two or more thereof.

Examples of electronically conductive materials that may be included in the electrode material comprise carbon black (such as Ketjen™ carbon, acetylene black, etc.), graphite, graphene, carbon nanotubes, carbon fibers (including carbon nanofibers, vapor grown carbon fibers (VGCF), etc.), non-powdery carbon obtained by carbonization of an organic precursor (e.g., as a coating on particles), or a combination of at least two of these.

Non-limiting examples of electrode material binders include the polymeric binders described above in connection with the thin layer or below for the electrolyte, but also rubber type binders such as SBR (styrene-butadiene rubber), NBR (acrylonitrile butadiene rubber), HNBR (hydrogenated NBR), CHR (epichlorohydrin rubber), and ACM (acrylate rubber), or fluorinated polymer binders such as PVDF (polyvinylidene fluoride), PTFE (polytetrafluoroethylene), and combinations thereof. Some binders, such as the rubber type binders, may also include an additive such as CMC (carboxymethyl cellulose).

Other additives may also be present in the electrode material, such as lithium salts or inorganic particles of ceramic or glass type, or other compatible active materials (e.g., sulfur).

The metallic film or electrode material may be applied on a current collector (e.g., aluminum, copper). According to one example, the current collector is made of carbon-coated aluminum. According to another alternative, the electrode may be self-supported.

The present document also relates to a process for the preparation of a surface modified electrode as described herein. This process comprises (i) mixing an inorganic compound and an optionally crosslinkable solvating polymer in a solvent, optionally comprising a salt and/or optionally a crosslinking agent; (ii) spreading the mixture obtained in (i) on the surface of the electrode; (iii) removing the solvent; and optionally (iv) crosslinking the polymer (e.g. ionically, thermally, or by irradiation). Steps (iii) and (iv) can also be reversed in some cases.

When the electrode is a metallic film such as lithium, steps (ii), (iii) and/or (iv) are preferably performed under vacuum or in an anhydrous chamber filled with an inert gas such as argon.

In the alternative, when the polymer is crosslinkable and is sufficiently liquid before crosslinking, the process can exclude the presence of solvent and step (iii) can be avoided.

Spreading can be done by conventional methods, for example, with a roller, such as a rolling mill roller, coated with the mixture (including a continuous roll-to-roll method), by doctor blade, spray coating, centrifuging, printing, etc.

The organic solvent used can be any solvent that is non-reactive with the metallic film or electrode material. Examples include tetrahydrofuran (THF), dimethylsulfoxide (DMSO), heptane, toluene, or a combination thereof.

Solid electrode-electrolyte components are also contemplated herein. These include at least one multilayer material comprising an electrode film, a thin layer as described above on the electrode film, and a solid electrolyte film on the thin layer.

For example, the solid electrolyte comprises at least one solvating polymer and a lithium salt. The solvating polymer of the electrolyte may be selected from linear or branched polyether polymers (e.g., PEO, PPO, or an EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer optionally comprising crosslinkable units and optionally being crosslinked. The lithium salts that may enter the solid electrolyte are as described for the thin layer.

However, although the salt of the solid electrolyte may be selected from those described above, it may be different or identical to that present in the thin layer. It should be noted that the present document also contemplates the use of the present electrodes with a polymer electrolyte of gel-type or of solid-type having properties approximating gel electrolytes.

According to another example, the solid electrolyte comprises a ceramic combined or not with a polymer as described in the previous paragraph. For example, the electrolyte is a composite comprising a polymer and at least one ceramic, which may be as described with respect to the thin layer. The solid electrolyte may also comprise a ceramic without the use of a polymer. Such ceramics include, for example, oxide type ceramics (such as LAGP, LLZO, LATP, etc.), sulfide type ceramics (such as Li₇P₃S₁₁), glass ceramics, and other similar ceramics.

The present technology also relates to electrochemical cells comprising a negative electrode, a positive electrode, and a solid electrolyte, wherein at least one of the electrodes is as described in the present application.

According to one example, the cell comprises the following elements stacked in order:
a metallic film as electrode material;
a thin layer as described herein and comprising an inorganic compound in an optionally crosslinked solvating polymer;
a solid electrolyte film; and
an electrode material film as described herein.

According to another example, the cell comprises the following elements stacked in order:
a metallic film as electrode material;
a solid electrolyte film;
a thin layer as described herein and comprising an inorganic compound in an optionally crosslinked solvating polymer; and
an electrode material film as described herein.

According to a third example, the cell comprises the following elements stacked in order:
a metallic film as electrode material;
a thin layer as described herein and comprising an inorganic compound in an optionally crosslinked solvating polymer;
a solid electrolyte film;
a thin layer as described herein and comprising an inorganic compound in an optionally crosslinked solvating polymer; and
an electrode material film as described herein.

The present document relates to an electrochemical accumulator comprising at least one electrochemical cell as defined herein. For example, the electrochemical accumulator is a lithium or lithium-ion battery.

According to another aspect, the electrochemical accumulators of the present application are intended for use in portable devices, e.g., cell phones, cameras, tablets or laptops, in electric or hybrid vehicles, or in renewable energy storage.

### EXAMPLES

The following non-limiting examples are illustrative embodiments and should not be construed as further limiting the scope of the present invention. These examples will be better understood by reference to the appended figures.

### Example 1 - Modification of Electrode Surface

### (a) Mg₂B₂O₅ (Rods), Polymer and Lithium Salt on Lithium or Alloy

A mixture containing 50% or 70% by weight of Mg₂B₂O₅ (rod-shaped ceramic), the rest (50% or 30%) being a mixture of salt (LiTFSI) and PEO-based crosslinkable polymer with an atomic ratio O:Li = 20:1, is prepared in tetrahydrofuran (THF). The whole mixture is dispersed with a disc mixer (Ultra-Turrax) until a stable suspension is obtained. The amount of THF is adjusted to obtain the right viscosity and to be at the limit of precipitating the ceramic at the bottom of the vessel. Typically, dispersions comprising around 20 to 25% by weight of the mixture “ceramic + polymer + salt + UV crosslinking agent” in the solvent are prepared and spread on a sheet of lithium (pure Li) or a LiₓM_{y} type alloy where x > y (e.g., Li alloys with Mg or Al) by doctor blade or by spray coater. Then, the lithium or lithium alloy sheet is placed in a glass enclosure under vacuum or in a chamber filled with an inert gas such as argon (avoid nitrogen, as it reacts quickly with lithium). Once the ambient air is removed, a UV lamp is turned on above the metallic film (on the spread layer’s side) to initiate the crosslinking (typically 300 WPI for 5 minutes at a 30 cm distance). The lithium foil is then dried at 80° C. under vacuum before being used in a battery.

A thermal curing agent can also be used instead of the UV crosslinking agent. In this case, the lithium foil is placed under vacuum at 80° C. at least overnight and is not treated under UV.

### (b) Al₂O₃ (Spherical), Polymer and Lithium Salt on Lithium or Alloy

A mixture containing 85% by weight of Al₂O₃ (ceramic in the form of small spheres with a small specific surface area of about 10 m²/g), the remainder (15%) being a mixture of salt (LiTFSI) and PEO-based crosslinkable polymer with an atomic ratio of O:Li = 20:1, is prepared in THF. The whole mixture is dispersed and the amount of THF is adjusted as in (a). Typically, dispersions comprising between 25 and 40% by weight of the mixture “ceramic + polymer + salt + thermal or UV crosslinker” are prepared and spread on a lithium or lithium alloy foil by doctor blade.

Subsequently, the lithium (or alloy) foil comprising the spread layer is placed directly in a vacuum oven, dried and cross-linked at 80° C. for at least 15 h before being used in a battery.

### (c) Al₂O₃ (Needles), Polymer and Lithium Salt on Lithium or Alloy

A mixture containing 50% by weight of Al₂O₃ (needle-shaped ceramic with a specific surface area of about 164 m²/g), the rest (50%) consisting of a mixture of salt (LiTFSI) and PEO-based crosslinkable polymer with an atomic ratio of O:Li = 20:1, is prepared in THF. The whole mixture is dispersed and the amount of THF is adjusted as in (a). Typically, dispersions comprising about 25% by weight of the mixture “ceramic + polymer + salt + thermal or UV crosslinker” are prepared and spread on a lithium (pure Li) or lithium alloy foil by spray coater. Subsequently, the piece of lithium (or alloy) comprising the spread layer is placed directly in a vacuum oven and dried at 80° C. for at least 15 h before being used in a battery.

Various surface-modified electrodes were produced by the above methods and are summarized in Table 1. The average thickness of the ceramic-polymer thin layer deposited on the lithium or lithium alloy of these electrodes ranges from 4 µm to 7 µm.

Table 1

Modified metallic electrodes

| Electrode | Method | Ceramic | Concentration | Metal^{a} |
|---|---|---|---|---|
| E1 | Ex. 1(b) | Al₂O₃ (spheres) | 85% | Li |
| E2 | Ex. 1(b) | Al₂O₃ (spheres) | 85% | LiMg |
| E3 | Ex. 1(b) | Al₂O₃ (spheres) | 85% | LiAl |
| E4 | Ex. 1(a) | Mg₂B₂O₅ | 50% | LiAl |
| E5 | Ex. 1(c) | Al₂O₃ (needles) | 50% | LiAl |

a. Li: pure lithium, LiMg: Li and Mg alloy (10 wt.%), and LiAl: Li and Al alloy (2000 ppm)

For comparison purposes, two LiAl electrodes coated with a mixture of ceramic and polymer with a thickness of 15-20 µm (70% spherical Al₂O₃) and 10-15 µm (85% spherical Al₂O₃), respectively, were also prepared. Properties of these electrodes and those in Table 1 are detailed in Example 2.

### (d) Al₂O₃ (Spherical), Polymer and Lithium Salt on LiFePO₄

A LiFePO₄ (LFP) electrode is prepared by mixing 73,5 wt.% of carbon-coated LFP P2, 1 wt.% of Ketjen™ ECP600 carbon, with the remainder (25.5%) being a mixture of polymer and LiFSI, is spread on a carbon-coated aluminum collector. The polymer is similar to that used for the thin layer of the metallic electrode, with a molar ratio of O:Li = 20:1.

A mixture of the polymer and LiTFSI (20:1) without ceramic with a UV initiator in THF is prepared and then spread by the doctor blade method on an LFP cathode. The cathode is then pre-dried for 5 min in an oven at 50° C. and then placed under a UV lamp (300 WPI) for 5 min in a nitrogen atmosphere. The polymer used is the same as the one used for the thin layer of the metallic electrode.

The same method was used to prepare different layers, but incorporating a ceramic (spherical Al₂O₃, 50 wt.%) in the mixture of the previous paragraph. Also, different O:Li ratios were tested: 5:1, 10:1, 15:1 and 20:1. A better preparation of the suspension can improve the quality of the thin layer.

### Example 2 - Properties of the Modified Electrodes

### (a) Modified Metallic Electrodes

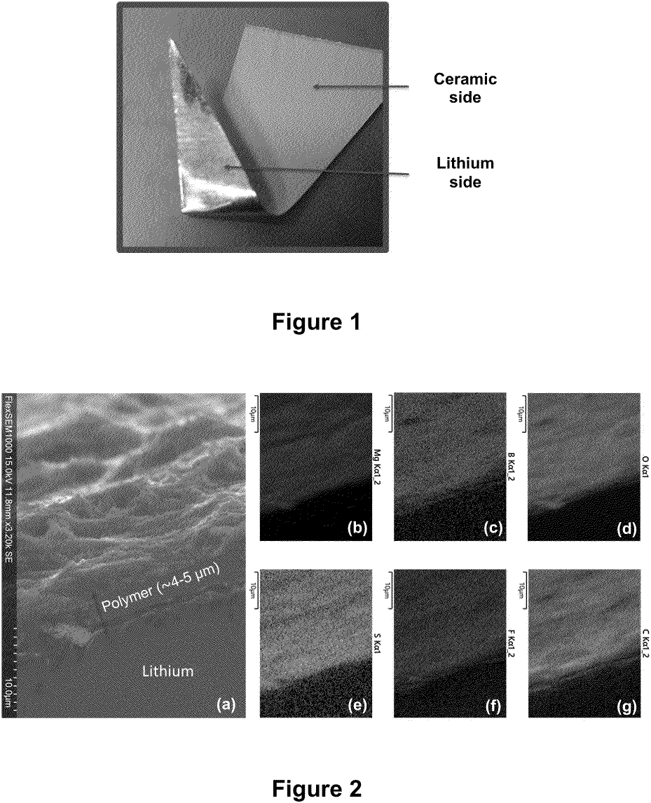

FIG. 1 shows a cross-section of a piece of metallic lithium having a thin ceramic layer (E1, 85% spherical Al₂O₃). The layer remains intact even during cutting and does not crumble, although highly concentrated in ceramic.

SEM (scanning electron microscopy) images were taken to visualize the different types of thin layers on lithium and its alloys.

There are two cases, for thin layers (around 5 µm) we talk about surface modification and for those of about 15-25 µm it is rather a solid polymer electrolyte (SPE) directly applied on the lithium electrode. Electrochemical tests for both cases will also be presented below to demonstrate the interest of modifying the surface rather than applying a SPE on the electrode.

FIG. 2 shows a thin layer of Mg₂B₂O₅ ceramic (E4, 50% by weight, 4-5 µm) on the surface of a LiAl alloy. The chemical mapping clearly shows the presence of sulfur (e) and fluorine (f) atoms attributed to the lithium salt, but mostly magnesium (b) atoms coming from the ceramic in the form of very hard rods, which gives a more or less homogeneous surface.

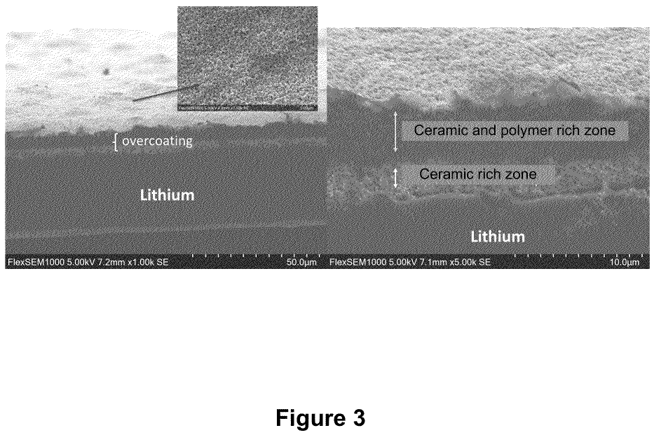

By using nanometric spheres of Al₂O₃ (spherical), the surface is more homogeneous, and the amount of ceramic can easily be increased up to 85% in order to make the progression of dendrites more difficult. FIG. 3 shows a thin layer of spherical Al₂O₃ ceramic (85% by weight, 6-7 µm) on the surface of a LiMg alloy (E2). In the image on the right, two layers are clearly visible, one rich in polymer and ceramic, the other very rich in ceramic. By playing with the rapid sedimentation of the ceramic when it is very concentrated in the composition of the ink to be applied to lithium, it is possible to form a very dense ceramic layer on the lithium surface. The top layer is richer in polymer and therefore stickier to provide a very good contact through the layer between the lithium and the solid polymer electrolyte (SPE) that will be hot laminated on the thin layer.

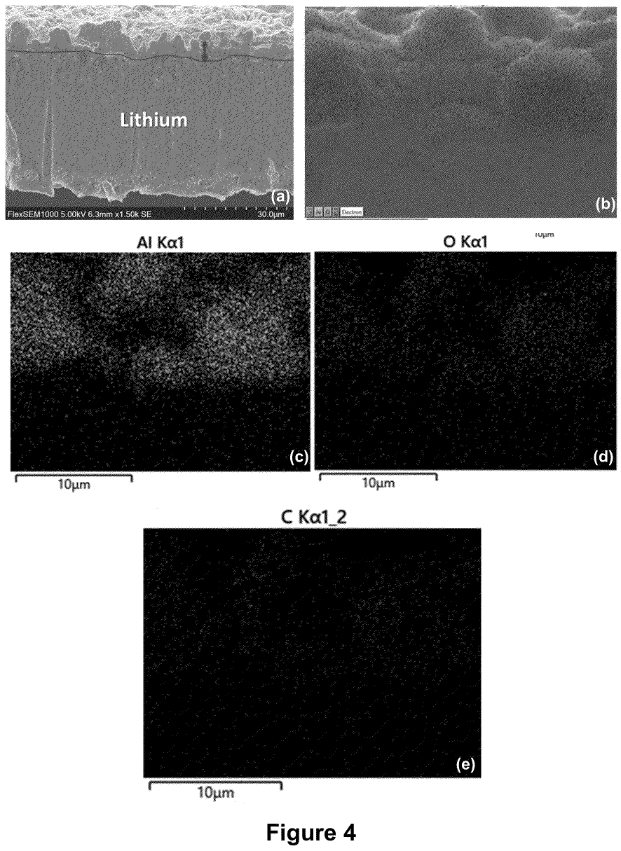

FIG. 4 shows another example of a thin layer this time with needle-shaped Al₂O₃ particles of nanometric size on a LiAl alloy (E5). Combined with the polymer, very dense agglomerates are obtained and because of the large specific surface of the ceramic only 50% by weight of the ceramic is used. Beyond that, all the polymer is consumed to coat the particles and the film formed on lithium is no longer strong enough to resist mechanical stress. The goal is to find the limit of dissolution of the ceramic in the polymer to form a thin and strong film while being the most concentrated in ceramic to obtain a “polymer in ceramic” type mixture different from what is usually reported for SPEs. In fact, small amounts of ceramic are rather added to SPEs in order to break the crystallinity of the polymer and create a Lewis acid/base competition between the polymer, lithium ions and oxygen-containing groups on the ceramic surface. Chemical mapping in FIGS. 4(b) to 4(e) shows that the small agglomerates are rich in aluminum (c), thus demonstrating the good dispersion of the ceramic so that the oxygen (d) and carbon (e) signals are barely visible.

In order to compare the electrochemical performance of a lithium having a thin ceramic layer and that of a lithium with an SPE (around 20 µm thick) deposited on its surface, tests of SPE deposition on lithium have also been carried out. These lithiums can be directly used with another electrode by hot pressing them without adding an additional SPE.

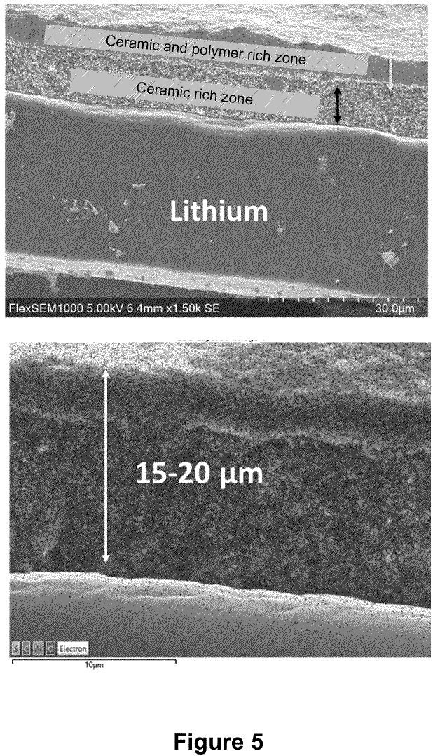

FIG. 5 shows an example of an SPE of about 15-20 µm directly deposited on a LiAl lithium alloy and composed of spherical Al₂O₃ ceramic (70% by weight) in the polymer used in Example 1. Two layers are clearly visible, one rich in polymer and ceramic, the other very rich in ceramic. In the lower layer, darker areas constituting the polymer are visible in the top image although the majority of this layer is composed of ceramic particles (in white). Of course, such an SPE will be less effective against dendrites since it is not dense enough in ceramic, but will be more sticky to be assembled with another electrode.

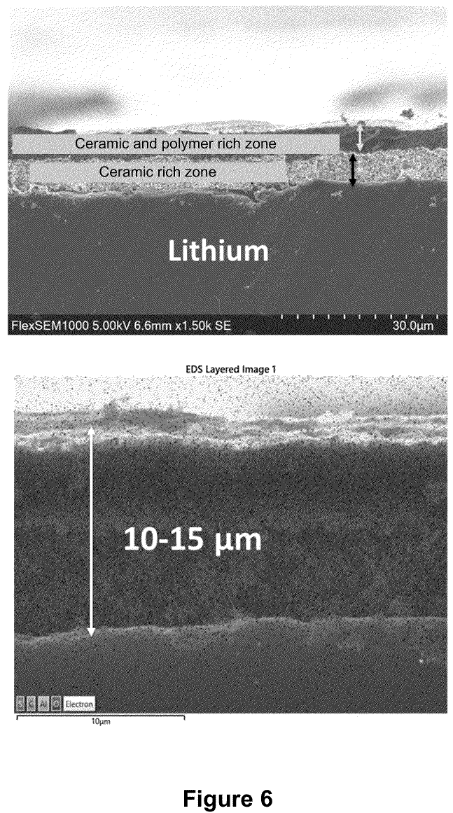

FIG. 6 shows another example of an SPE (about 10-15 µm) deposited on the surface of the LiAl lithium alloy, but this time with 85 wt.% of spherical Al₂O₃ ceramic particles in the same polymer. Again, two layers are clearly visible, the first rich in polymer and ceramic, the second very rich in ceramic. Fewer dark areas are visible in the lower layer compared to FIG. 5 since it is more ceramic rich. This type of SPE would therefore be more effective against dendrites than the example comprising 70% ceramic. However, these last two layers, although thicker, are still not suitable for use as a solid electrolyte since their surface is not sticky enough to adhere to the cathode.

### (b) Modified Composite Electrode

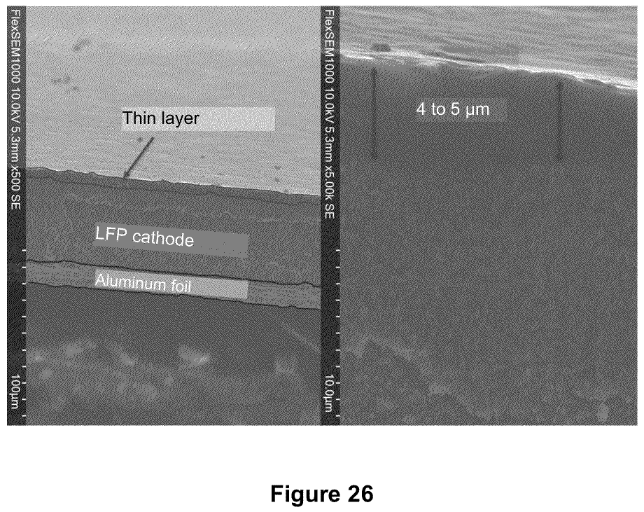

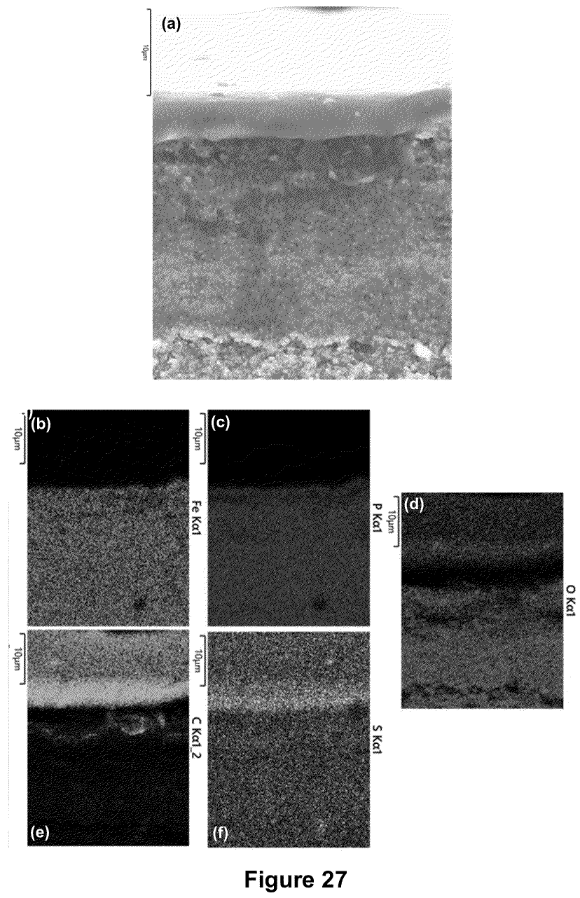

The electrodes (with and without ceramics) prepared according to Example 1(d) were analyzed. FIG. 26 shows the thin layer of polymer and salt without ceramics. This layer has a thickness of 4 to 5 µm. FIG. 27 shows the chemical mapping of the electrode edge. The sulfur (f) in the salt and the carbon (e) in the polymer are clearly visible.

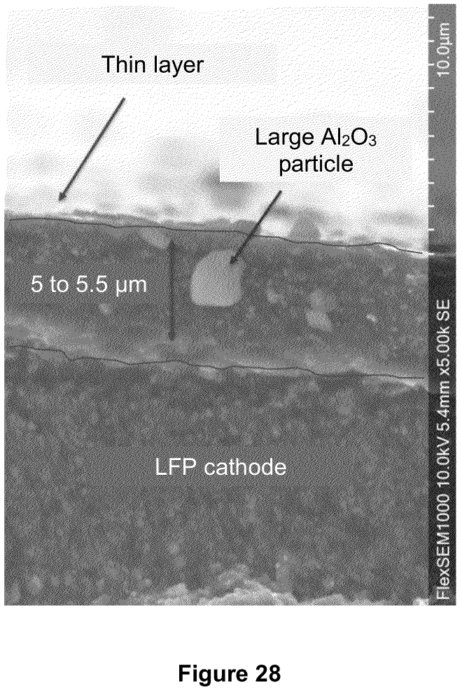

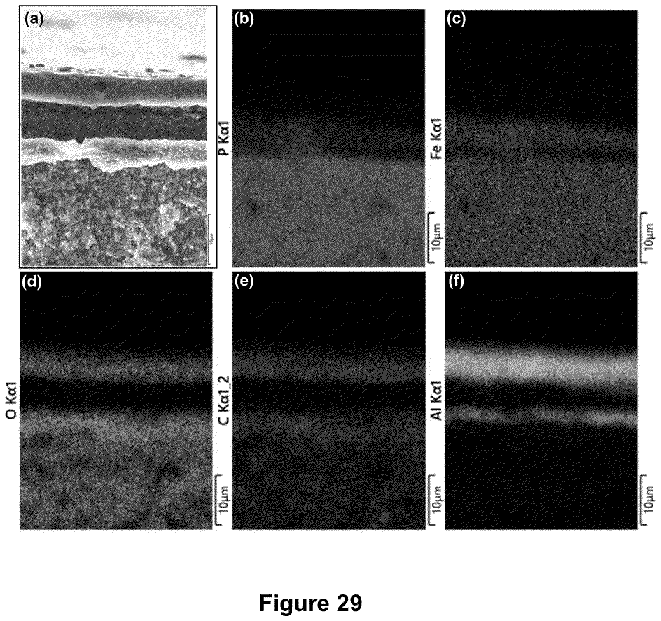

Electrodes with the thin layer comprising spherical Al₂O₃ ceramic and the polymer and lithium salt mixture at different O:Li molar ratios (5:1, 10:1, 15:1, and 20:1) were also analyzed. FIG. 28 shows a thin layer of polymer and salt (O:Li ratio 20:1) containing 50 wt.% Al₂O₃ and measuring approximately 5 to 5.5 µm thickness. The chemical mapping of this same electrode is shown in FIG. 29.

### Example 3 - Preparation of Symmetrical or Complete Cells

Symmetrical Li/SPE/Li and complete LFP/SPE/Li cells were assembled. These cells were prepared using either the electrodes in Table 1 or comparative electrodes (without thin layer). The configuration of each is presented in Tables 2 and 3.

The electrolyte (SPE) is composed of a mixture of salt (LiTFSI) and PEO-based crosslinkable polymer with an atomic ratio of O:Li = 20:1. This mixture is spread on a substrate and crosslinked. The electrodes are then hot rolled onto the SPE at 80° C., under vacuum in an anhydrous chamber or in a glove box under argon in the case of lithium.

The LFP (LiFePO₄) cathode is composed of carbon-coated LFP P2 (75.3%), Ketjen™ black (1%), polymer (19.23%), LiTFSI (6.27%). The polymer is the same as the one used for the thin layer and SPE, with a molar ratio of O:Li = 20:1.

Table 2

Evaluated cells (Electrode A/SPE/Electrode B)

| | | | |
|---|---|---|---|
| Cell | Type^{a} | Electrode A | Electrode B |
| P1 | S | E3 | E3 |
| P2 | S | E1 | E1 |
| P3 | S | E5 | E5 |
| P4 | S | E5 | LiAl^{b} |
| P5 | C | E5 | LFP |
| P6 | C | E3 | LFP |
| P7 | C | E2 | LFP |
| P8 | C | E1 | LFP |

a. S: symmetrical, C: complete
b. LiAl: alloy of Li and Al (2000 ppm)

Table 3

Comparative cells (Electrode A/SPE/Electrode B)

| | | | |
|---|---|---|---|
| Cell | Type^{a} | Electrode A^{b} | Electrode B^{b} |
| P(a) | S | Li | Li |
| P(b) | S | LiAl | LiAl |
| P(c) | S | LiMg | LiMg |
| P(d) | S^{c} | LiAl | LiAl |
| P(e) | C | LiAl | LFP |
| P(f) | C | LiMg | LFP |
| P(g) | C | Li | LFP |

a. S: symmetrical, C: complete
b. Li: pure lithium, LiMg: alloy of Li and Mg (10 wt.%), and LiAl: alloy of Li and Al (2000 ppm)
c. SPE for P(d): 85% Al₂O₃ (spheres) in the polymer, 25 µm

These cells were analyzed and then tested under cycling conditions. The properties of these batteries are presented in the following example.

### Example 4 - Properties of Symmetrical or Complete Cells

### (a) Symmetrical Cells with Unmodified Lithium or Lithium Alloy

SEM images were taken of a symmetrical cell including an unmodified metallic film in order to compare it with those obtained with cells whose metallic film (Li or Li alloy) was modified using the present method.

Symmetrical Li/SPE/Li cells were also galvanostatically cycled by applying various constant currents ranging from C/24 to 1C. Cyclability tests were also performed by allowing the battery to cycle at C/4 until short circuit. Impedance measurements on the cells were performed at 50° C.

### i. With Pure Unmodified Lithium (P(a) Cell)

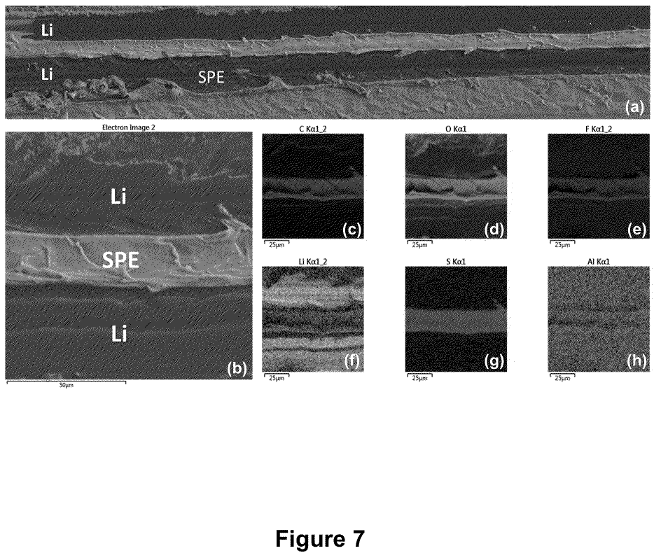

FIG. 7 shows an SEM image depicting the Li/SPE/Li stack after disassembly of a cell that has been cycled and shorted. Dendrites are not visible on the cell cross-section analyzed by SEM but could be present elsewhere in the cell. Note that the aluminum element shown in the chemical mapping comes from the support behind the sample and not from the sample itself.

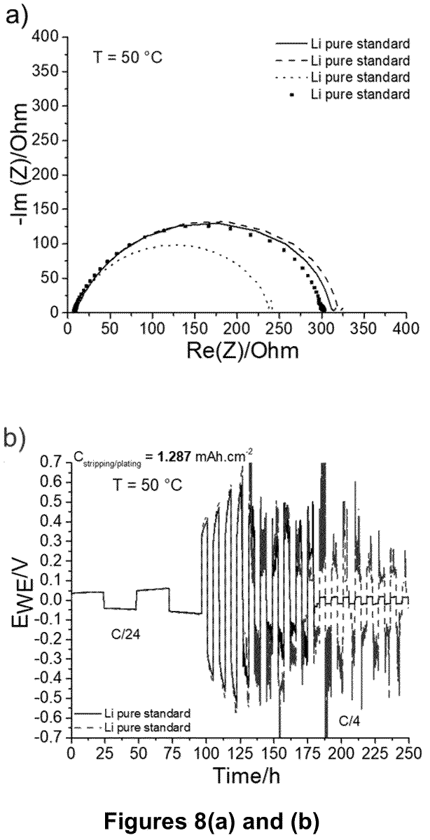

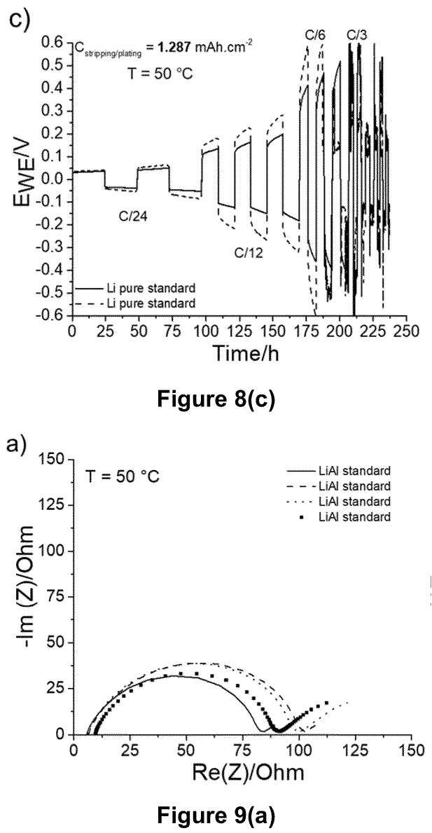

Measurements of impedance, cycling stability at a C/4 regime, and resistance at various applied currents were performed. Four P(a) cells were tested and showed relatively similar impedance curves (see FIG. 8(a)). The charge transfer interface appears not to be very efficient, and the half arcs are larger.

P(a) cells were then tested for stability. After the two formation cycles in C/24, the cells tested in C/4 show a rapid increase in potential and at the 4^{th} cycle, abrupt changes in response to the applied current are visible and the batteries short-circuit quickly (see FIG. 8(b)). For FIG. 8(c), it is clearly visible that the other 2 P(a) cells do not resist for very long when a current of C/6 is applied.

### ii. With Unmodified LiAl Lithium Alloy (P(b) Cell)

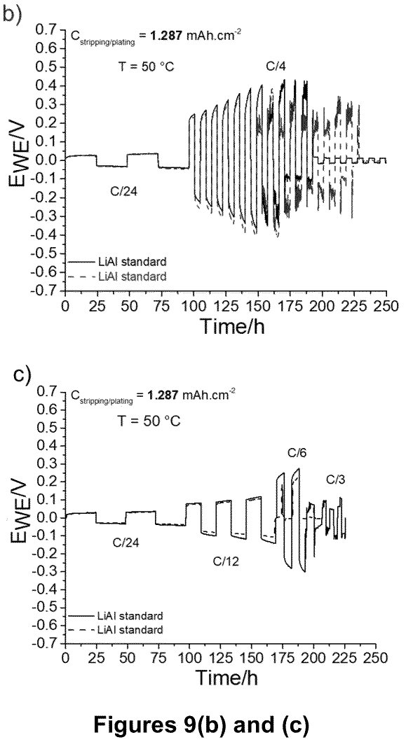

FIG. 9(a) shows spectroscopic impedance measurements performed at 50° C. for four symmetrical P(b) cells assembled with standard LiAl alloys. Two of these same cells were studied in cycling stability at a C/4 rate (FIG. 9(b)) and two others in a resistance test at various applied currents (FIG. 9(c), rate capability).

Impedances are very close for the 4 different P(b) cells which shows that the assembly is reproducible. After the two formation cycles in C/24, the batteries tested in C/4 show a rapid increase in overpotential and by the 7^{th} cycle, abrupt changes in response to the applied current are visible and the batteries short-circuit rapidly. For FIG. 9(c), it is clearly visible that the P(b) cells do not withstand more than 2 cycles when a C/6 current is applied.

### iii. With Unmodified LiMg Lithium Alloy (P(c) Cell)

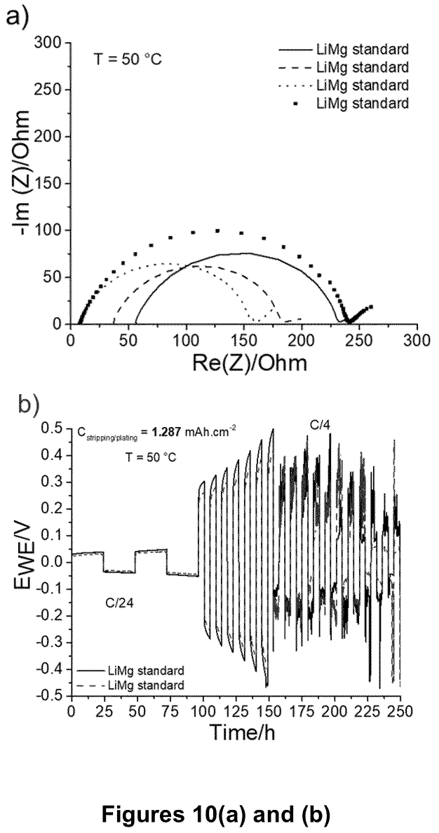

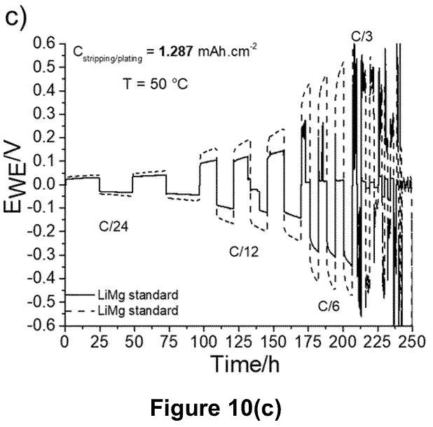

FIG. 10 shows the same tests as FIG. 9 except that LiMg alloys were used. The charge transfer interface appears to be less efficient, and the half arcs are larger. As for the LiAl alloy, the batteries die after about 150 hours at a constant current of C/4 and do not withstand the application of a current equivalent to C/6.

### iv. With Unmodified LiAl and SPE with Ceramic (P(d) Cell)

Further electrochemical tests have been performed to demonstrate that the surface modification of lithium (thin layer of about 5 µm) is advantageous to increase the lifetime and cycling quality of the lithium battery. The lithium modified with a thin layer has to be combined with a SPE and a cathode (itself containing or not a thin layer which can be of the same nature). After rolling the stack at 80° C., the contact between the components is very good and the ceramic-rich protective layer is retained on the lithium side.

If, for example, an SPE containing a high percentage of ceramic (e.g., 70%) is formed on a polypropylene film and then peeled off and laminated between two lithium films, the experiment does not work because the SPE is not strong enough nor sticky enough to adhere to the electrode films.

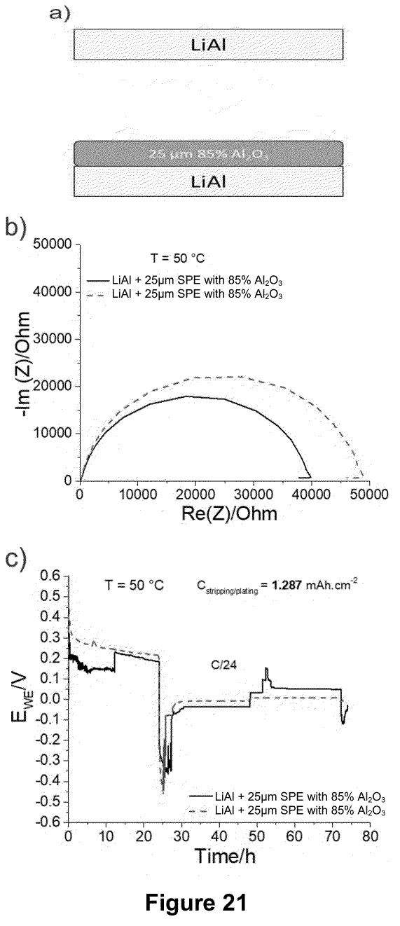

Another test, shown in FIG. 21(a) consists in depositing the SPE directly on the lithium (see also FIGS. 5 and 6). When the thickness is too great an SPE cannot be added, and this type of coating is not adherent enough to make a good contact with the second unmodified lithium. The impedance measurements in FIG. 21(b) show huge charge transfer resistances due to the poor physical contact between the two lithiums and the coating, and to the excessive amount of ceramic which becomes detrimental in this scenario. As shown in FIG. 21(c), the batteries cannot be cycled and die prematurely.

### (b) Symmetrical Cells with Modified Lithium or Lithium Alloy

SEM images were taken of symmetrical cells including a modified metallic film in order to compare them with those obtained with the cell whose metallic film was not modified (see in (a)).

Surface-modified Li/SPE/Li symmetrical cells were also galvanostatically cycled by imposing various constant currents ranging from C/24 to 1C. Cyclability tests were also performed by allowing the battery to cycle at C/4 until short-circuiting. Impedance measurements were performed on the cells at 50° C.

### i. With LiAl Lithium Alloy Modified with 85% Spherical Al₂O₃ (P1 Cell)

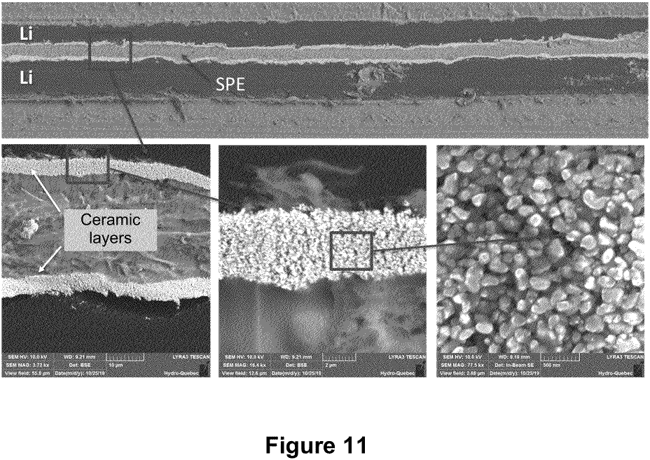

FIG. 11 shows an SEM image of a stacking after cycling with two lithiums (LiAl) covered by a 4 µm thin layer of spherical Al₂O₃ ceramic (85% by mass). Dendrites are not visible, but the P1 cell shown is presented after short circuiting. Even during cycling, the ceramic layer remains compact, which provides a protection to slow down the progression of dendrites. At the highest magnification, it is clear that each ceramic particle (small sphere) is coated with polymer in a “polymer-in-ceramic” configuration rather than a ceramic incorporated in a polymer as usually reported.

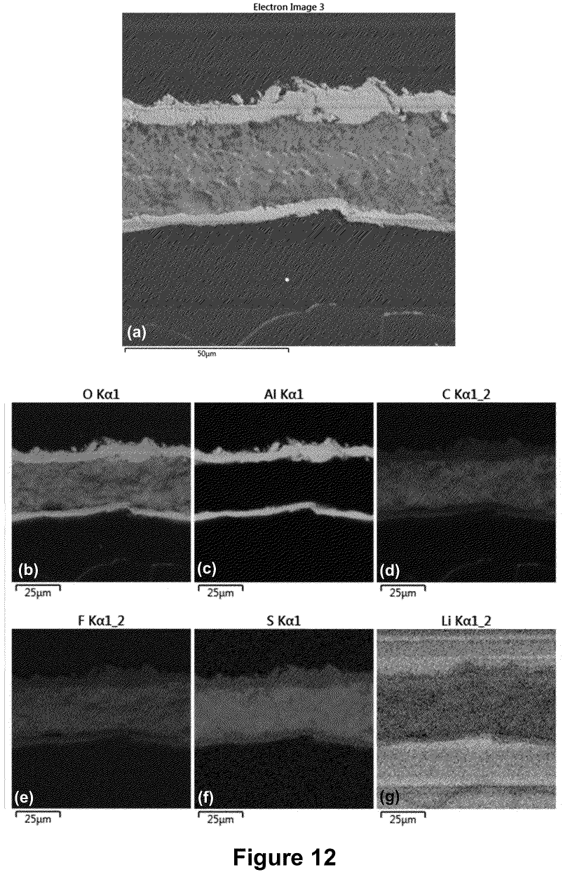

FIGS. 12(a) to 12(g) show the SEM image and chemical mapping of the P1 cell, the latter showing the Al₂O₃ layer clearly. Locally, the ceramic layer is a bit deformed because of the repeated high current cycling it was subjected to.

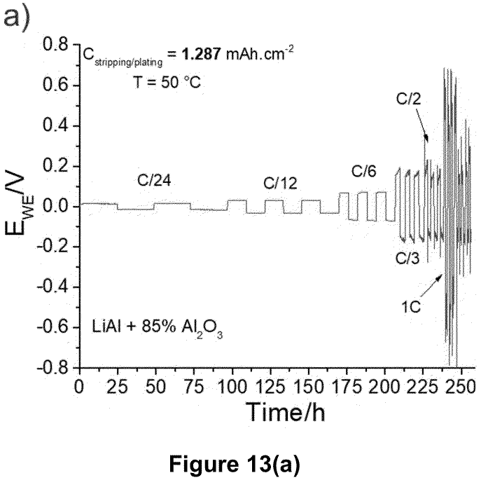

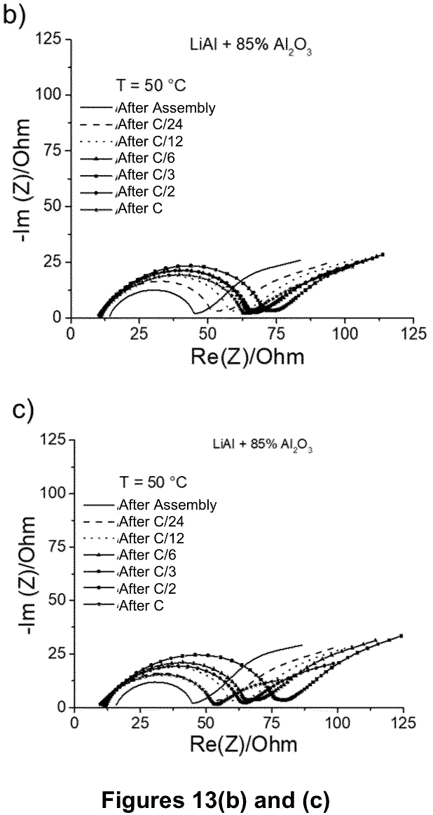

FIG. 13(a) clearly shows that the protected lithium of P1 can cycle without short-circuiting up to a 1 C rate with a small overvoltage. FIGS. 13(b) and 13(c) show spectroscopic impedance measurements made at 50° C. for 2 symmetrical P1 cells after assembly and after each cycling rate. Impedances are relatively stable during cycling which attests that the lithium does not undergo strong deformation even when a high current is applied.

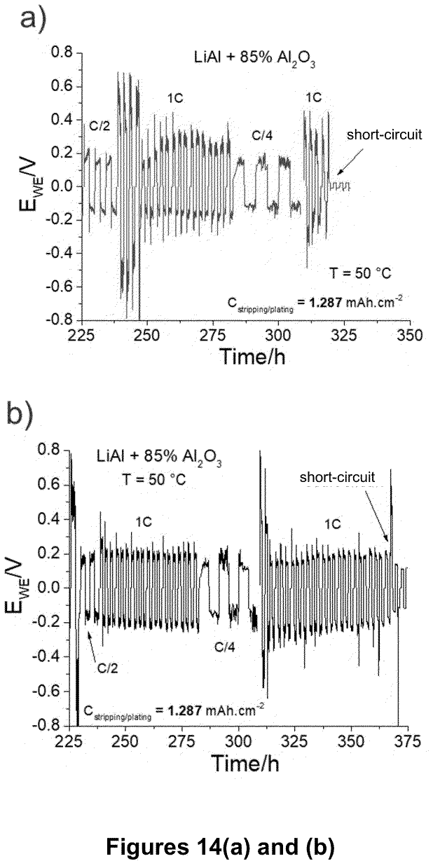

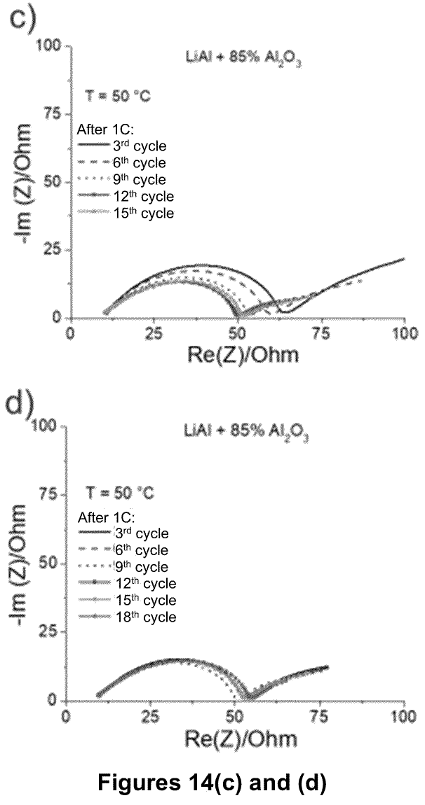

FIGS. 14(a) and 14(b) show the cycling at 1 C for several cycles of these same P1 cells. Both batteries short-circuit between 320-360 hours of cycling which shows a clear improvement over the results of FIG. 9. Also, impedances shown in FIGS. 14(c) and 14(d) are stable during the high current cycling of 1C (results shown every three cycles in 1C).

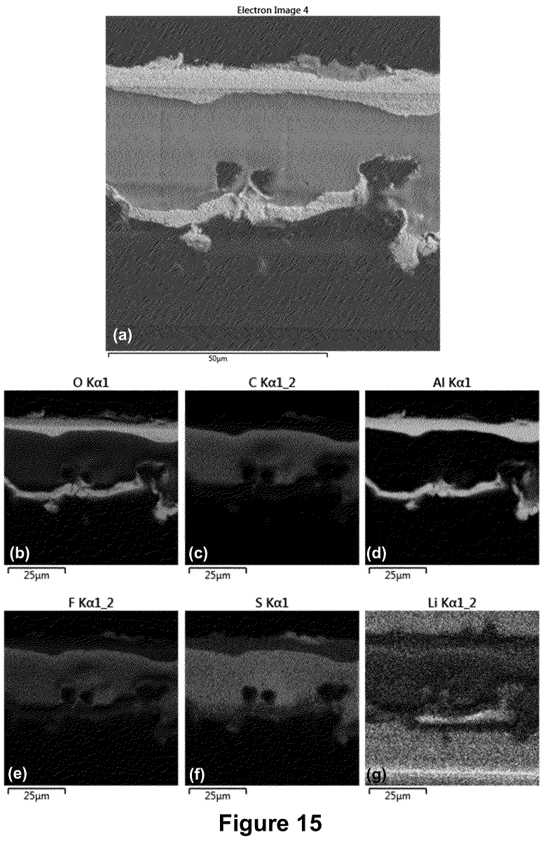

FIG. 15 shows an example of a cell that has cycled and shorted. The cell shown is the one whose cycling is shown in FIG. 14(a). In this SEM image, the passage of two dendrite formations is clearly highlighted. Chemical mapping shows that the Al₂O₃ layer has been breached by dendrites and that it is heavily destroyed compared to what can be seen in the SEM images of FIG. 12.

### ii. With Lithium Modified with 85% Spherical Al₂O₃ (P2 Cell)

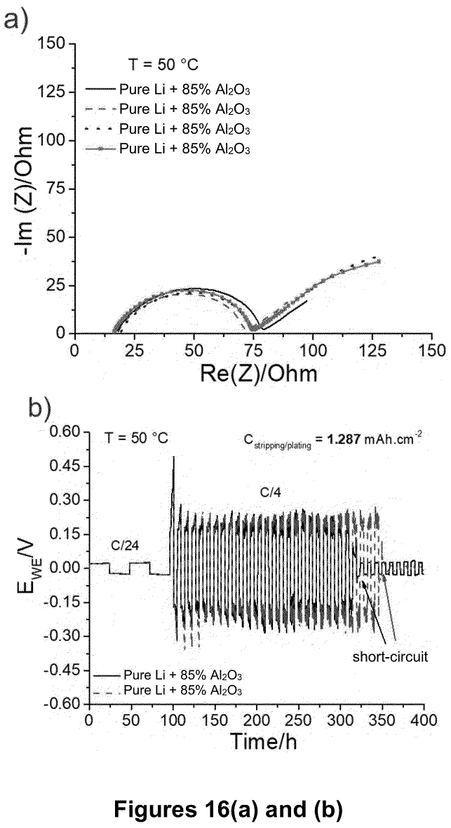

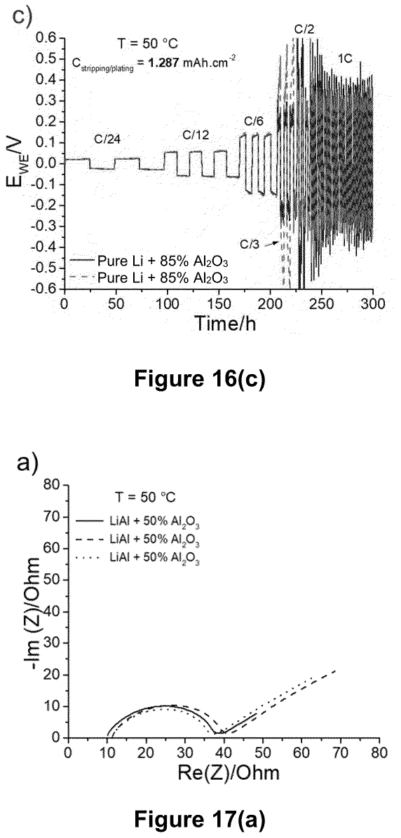

P2 cells were also assembled with pure lithium and a thin layer containing 85% spherical Al₂O₃ ceramic. The electrochemical results are shown in FIG. 16. Impedances are highly reproducible for the 4 assembled cells (FIG. 16(a)). It takes between 300 and 350 hours before the cells short-circuit under a constant current of C/4 (FIG. 16(b)) whereas before surface modification the battery died after only 120 hours. Also, the battery withstands high currents up to 1C and can cycle for more than 300 hours (FIG. 16(c)).

### iii. With LiAl Lithium Alloy Modified with 50% Needles Al₂O₃ (P3 Cell)

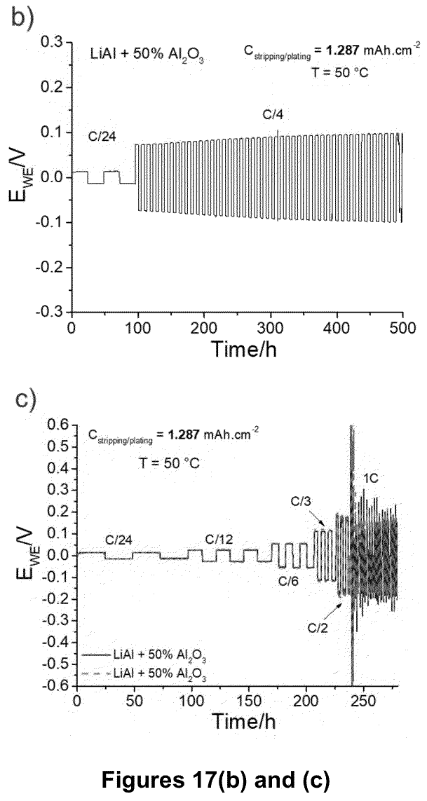

Very good results were obtained with P3 cells comprising lithium coated with 50% Al₂O3 in the form of needles (see also the SEM images in FIG. 4). Electrochemical results for an LiAl alloy coated with 50% Al₂O₃ are shown in FIG. 17. FIG. 17(a) shows highly reproducible impedances for all three cells. In FIG. 17(b), it can be observed that the battery life has been increased by 8 times, since before modification it could cycle only 50 h in C/4 compared to 400 h in this case. The charge/discharge rate capability in FIG. 17(c) shows a very low bias cycling profile, which demonstrates the stability of the interface between the lithium and the SPE.

### iv. With LiAl Modified with 50% Needles Al₂O₃ and Unmodified LiAl (P4 Cell)

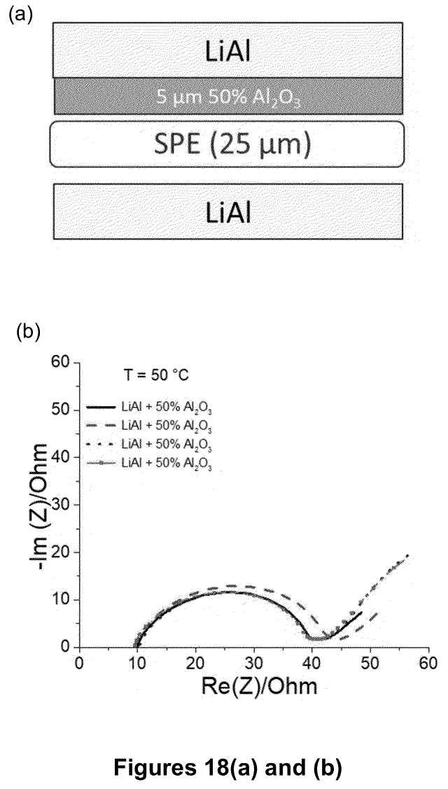

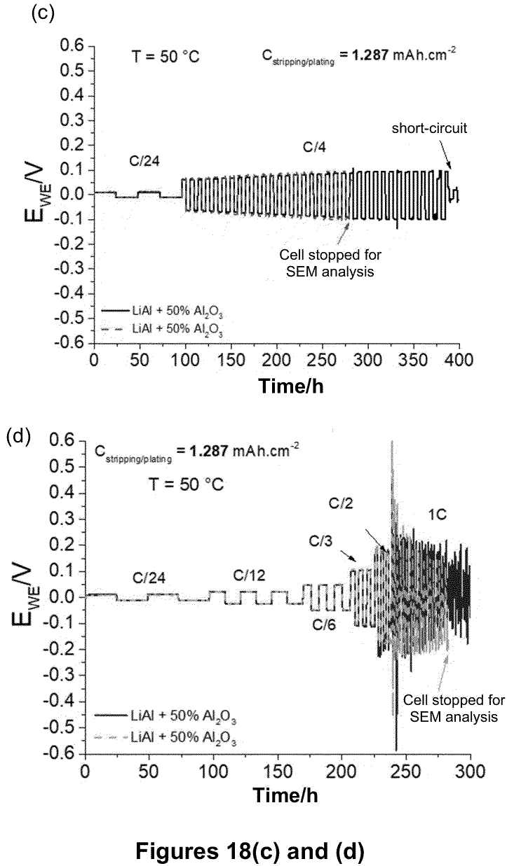

In order to highlight the formation of dendrites within the battery and to emphasize the protective role of the ceramic thin layer, LiAl/SPE/LiAl cells with only one side coated with a thin layer of Al₂O₃ (needles, 50%) were assembled and cycled. Cycling of the batteries was stopped before shorting as shown in the cycling profiles in FIG. 18. FIG. 18(a) shows the assembly performed to study the effect of the protective layer on lithium deformation, while FIG. 18(b) shows the impedance results of four assembled batteries.

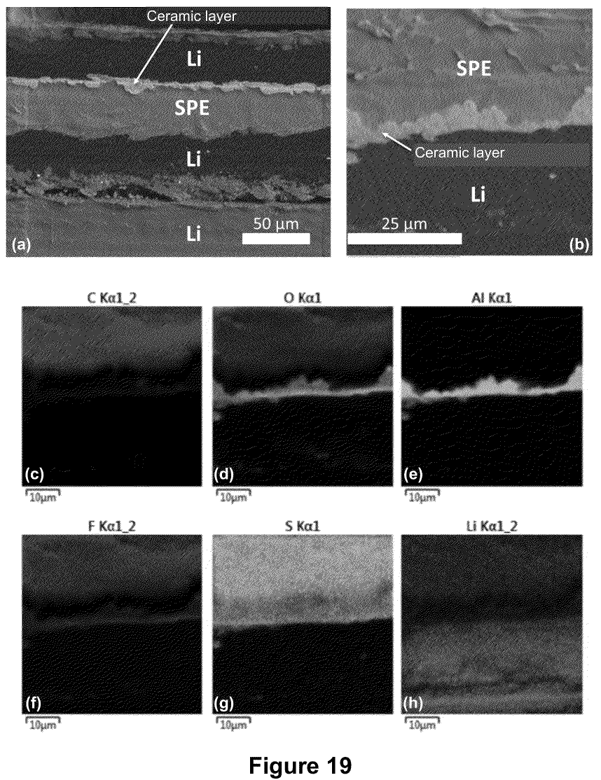

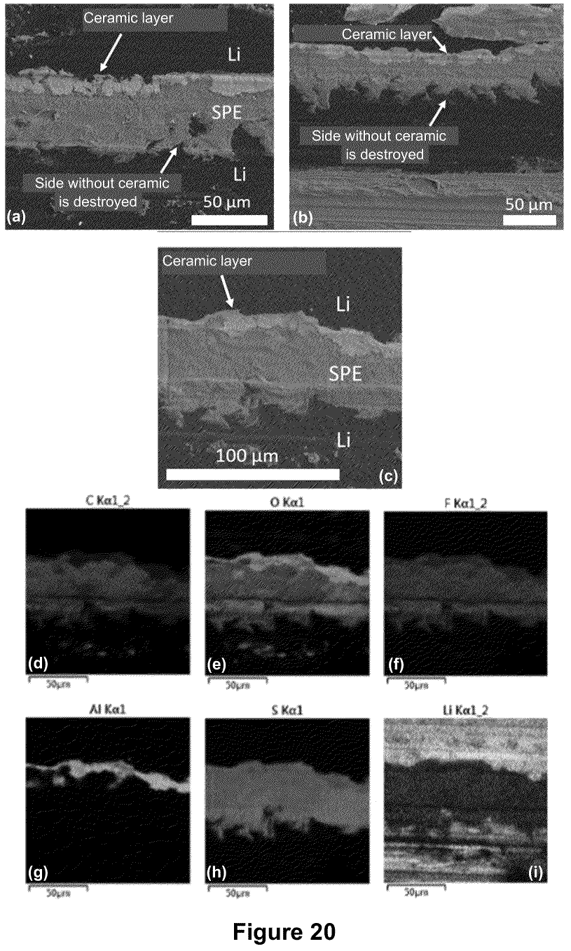

A cross-section of the battery that has cycled at low current (C/4, cell in FIG. 18(c)) was observed by SEM and the images are shown in FIG. 19. Since there was no short circuit, both interfaces appear to be intact and not too deformed. On the contrary, for the cell that was cycled up to 1 C (cell in FIG. 18(d)), the SEM observation and chemical mapping of the Li/SPE/Li stack, shown in FIG. 20, reveal a strong deformation on the unprotected lithium side with the presence of deactivated lithium in the SPE. Conversely, the lithium on the ceramic side remains intact and the ceramic layer has not been destroyed.

### (c) Comparatives Studies on Complete LFP/SPE/Li Cells

Full-cell electrochemical tests with LiFePO₄ (LFP) as the cathode material were performed to confirm the positive effect of the thin layer (about 5 µm) on the lithium surface.

### i. Complete Cells with LFP/SPE/LiAl (P(e), P5 and P6 Cells)

Complete cells including unmodified LiAl (P(e)), LiAl modified with 50% Al₂O₃ needles (P5), and LiAl 85% Al₂O₃ spherical (P6) are tested under the same conditions.

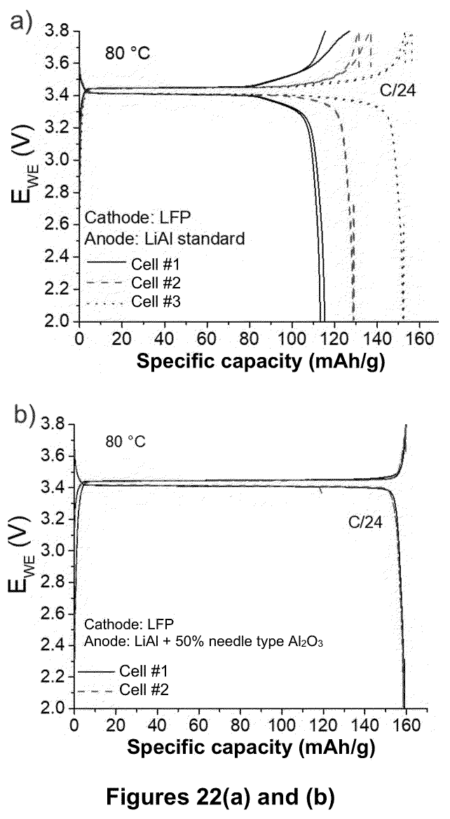

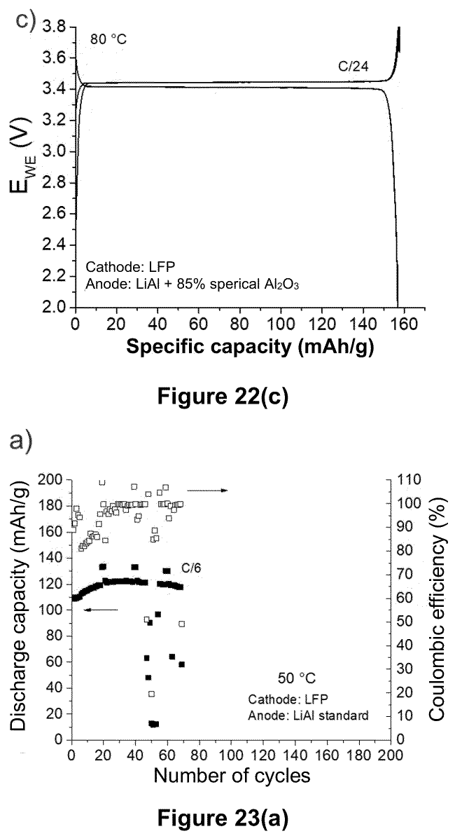

FIG. 22 shows that the first two charge/discharge curves are perfect, with little polarization and a very well-defined plateau at 3.5 V when the modified LiAl alloys are used (FIGS. 22(b) and (c)). Moreover, the results are reproducible. For example, two batteries are present in FIG. 22(b) and the curves overlap. When the unmodified LiAl lithium is used, the results are not very reproducible as can be seen in FIG. 22(a). The discharge capacity is also smaller, and the plateau is less well defined for all three cells.

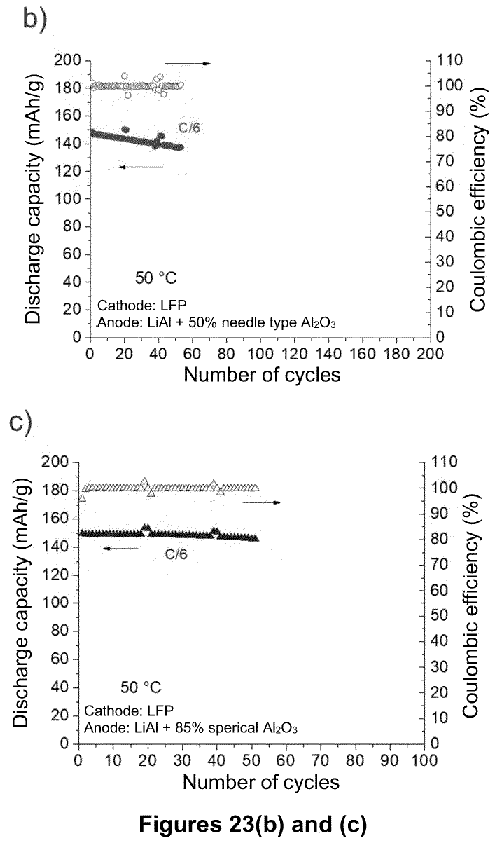

Long C/6 cycling studies were performed for these different batteries. Their cyclabilities are shown in FIG. 23(a) for unmodified lithium (P(e) cell), FIG. 23(b) for lithium with a layer containing 50% needle-shaped Al₂O₃ (P5 cell) and FIG. 23(c) for lithium with a layer containing 85% spherical Al₂O₃ (P6 cell). The cycling and coulombic efficiency are much more stable when modified lithiums are used. On the other hand, the low coulombic efficiency for the battery assembled with the unmodified LiAl reveals that secondary reactions occur at the lithium level (deformation or lithium consumption).

### ii. Complete Cells with LFP/SPE/LiMg (P7 and P(f) Cells)

Very similar results were obtained with the LiMg alloy modified with a thin ceramic layer (85% spherical Al₂O₃, P7 cell) compared to the equivalent battery with unmodified LiMg (P(f) cell). FIG. 24 shows the long cycling studies at C/6 and C/2 for the LFP/SPE/LiMg batteries employing the unmodified LiMg (FIG. 24(a)) and the one modified with the ceramic (FIG. 24(b)). Once again, the cycling is more stable after lithium modification and particularly at C/2. Indeed, at this rate the progression of dendrites is favored and thus the formation of a short circuit. For example, after 45 cycles in C/2 for the P(f) battery with unmodified LiMg, the coulombic efficiency drops drastically and oscillates around 40% demonstrating the formation of dendrites. Conversely, for the C/2 cycling in FIG. 24(b) for P7, the coulombic efficiency remains stable throughout cycling.

### iii. Complete Cells with LFP/SPE/Li (P8 and P(g) Cells)

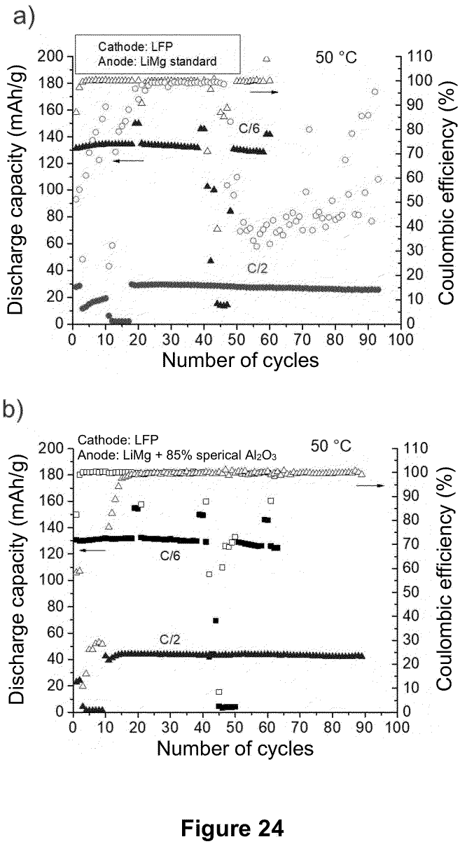

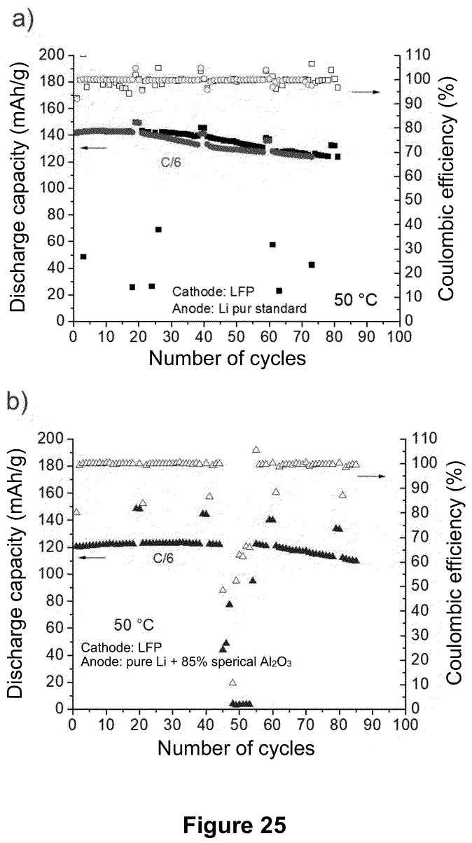

Finally, tests with pure Li for the P(g) (unmodified Li) and P8 (Li modified with 85% spherical Al₂O₃) batteries also showed an advantage to using surface-modified lithium. FIG. 25(a) shows a rapid capacity loss for both batteries assembled with pure Li without modification and coulombic efficiency varies more than when using pure Li lithium with a ceramic layer. For the cycling in FIG. 25(b), it is relatively stable at the beginning, then a current interruption between the 45^{th} and 55^{th} cycles causes the capacity to drop and the cycling seems to be affected thereafter, but the coulombic efficiency still remains around 100%.

### iv. Complete Cells with LFP/SPE/LiAl (with Modified LFP)

LFP/SPE/Li coin cells were assembled as follows:
a standard unmodified LiAl anode;
a free-standing SPE 20 µm thick and containing the polymer used in the thin layer and LiTFSI (O:Li of 30:1);
an LFP cathode as described in Example 1(d) with a ceramic thin layer (50% Al₂O₃ and O:Li ratio of 10:1) or without thin layer (reference).

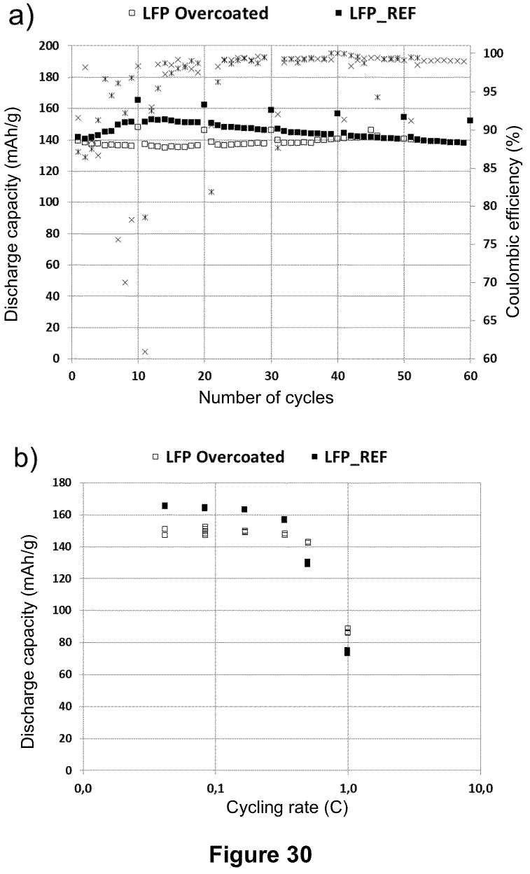

FIGS. 30(a) and 30(b) show the long cycling experiments (charge: C/6, discharge: C/3) and cycling at different rates at 80° C. in coin cell, respectively.

Several modifications could be made to any of the above-described embodiments without departing from the scope of the present invention as contemplated. The references, patents or scientific literature documents referred to herein are incorporated by reference in their entirety for all purposes.

1. Electrode comprising a metallic film modified by a thin layer, wherein:
the metallic film comprises lithium or an alloy comprising lithium, the metallic film comprising a first and a second surfaces; and
the thin layer comprises an inorganic compound in a solvating polymer, the thin layer being disposed on the first surface of the metallic film and having an average thickness of about 10 µm or less, the inorganic compound being present in the thin layer at a concentration between about 40% and about 90% by weight.

2. The electrode of claim 1, wherein the polymer is crosslinked.

3. The electrode of claim 1 or 2, wherein the metallic film comprises lithium comprising less than 1000 ppm (or less than 0.1 wt.%) of impurities.

4. The electrode of claim 1 or 2, wherein the metallic film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g., Zr, Cu, Ag, Bi, Co, Zn, Al, Si, Sn, Sb, Cd, Hg, Pb, Mn, B, In, TI, Ni, or Ge).

5. The electrode of claim 4, wherein the alloy comprises at least 75 wt.% lithium, or between 85% and 99.9 wt.% lithium.

6. The electrode of any one of claims 1 to 5, wherein the metallic film further comprises a passivation layer on the first surface, the first surface being in contact with the thin layer.

7. The electrode of claim 6, wherein the passivation layer comprises a compound selected from a silane, a phosphonate, a borate or an inorganic compound (such as LiF, Li₃N, LisP, LiNO₃, Li₃PO₄).

8. The electrode of any one of claims 1 to 7, wherein the first surface of the metallic film is modified by stamping beforehand.

9. The electrode of any one of claims 1 to 10, wherein the inorganic compound is in the form of particles (e.g., spherical, rod-like, needle-like, etc.).

10. The electrode of claim 9, wherein the average particle size is less than 1 µm, less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or again between 50 nm and 200 nm, or between 100 nm and 200 nm, or between 1 nm and 100 nm, or between 10 nm and 100 nm, or again between 25 nm and 100 nm, or between 50 nm and 100 nm.

11. The electrode of claim 9 or 10, wherein the inorganic compound comprises a ceramic.

12. The electrode of any one of claims 9 to 11, wherein the inorganic compound is selected from AI2O₃, Mg₂B₂Os, Na₂O-2B₂O₃, xMgO·yB₂O₃·zH₂O, TiO₂, ZrO₂, ZnO, Ti₂Os, SiO₂, Cr₂O₃, CeO₂, B₂O₃, B₂O, SrBi₄Ti₄O₁₅, LLTO, LLZO, LAGP, LATP, Fe₂O₃, BaTiOs, γ-LiAlO₂, molecular sieves and zeolites (e.g., of aluminosilicate, of mesoporous silica), sulfide ceramics (such as Li₇P₃S₁₁), glass ceramics (such as LIPON, etc.), and other ceramics, as well as their combinations.

13. The electrode of any one of claims 9 to 12, wherein the inorganic compound particles further comprise organic groups covalently grafted to their surface, for example, said groups being selected from crosslinkable groups (such as organic groups comprising an acrylate function, a methacrylate function, a vinyl function, a glycidyl function, a mercapto function, etc.), aryl groups, alkylene oxide or poly(alkylene oxide) groups, and other organic groups.

14. The electrode of any one of claims 9 to 13, wherein the particles of the inorganic compound have a small specific surface area (e.g., less than 80 m²/g, or less than 40 m²/g).

15. The electrode of claim 14, wherein the inorganic compound is present in the thin layer at a concentration between about 65 wt.% and about 90 wt.%, or between about 70 wt.% and about 85 wt.%.

16. The electrode of any one of claims 9 to 13, wherein the particles of the inorganic compound have a large specific surface area (e.g., of 80 m²/g and above, or of 120 m²/g and above).

17. The electrode of claim 16, wherein the inorganic compound is present in the thin layer at a concentration between about 40 wt.% and about 65 wt.%, or between about 45 wt.% and about 55 wt.%.

18. The electrode of any one of claims 1 to 17, wherein the average thickness of the thin layer is between about 0.5 µm and about 10 µm, or between about 1 µm and about 10 µm, or between about 2 µm and about 8 µm, or between about 2 µm and about 7 µm, or between 2 µm and about 5 µm.

19. The electrode of any one of claims 1 to 18, wherein the solvating polymer is selected from linear or branched polyether polymers (e.g., PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, optionally comprising crosslinked units derived from crosslinkable functions (such as acrylate function, methacrylate function, vinyl function, glycidyl function, mercapto function, etc.).

20. The electrode of any one of claims 1 to 19, wherein the thin layer further comprises a lithium salt.

21. The electrode of claim 20, wherein the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)_{3]} (LiFAP), lithium tetrakis(trifluoroacetoxy)borate Li[B(OCOCF₃)_{4]} (LiTFAB), lithium bis(1,2-benzenediolato(2-)-O,O′)borate Li[B(CeO₂)_{2]} (LBBB), and a combination thereof.

22. The electrode of any one of claims 1 to 21, further comprising a current collector in contact with the second surface of the metallic film.

23. Electrode comprising an electrode material film modified by a thin layer, wherein:
the electrode material film comprises an electrochemically active material, optionally a binder, and optionally an electronically conductive material, the electrode material film comprising a first and a second surface; and
the thin layer comprises an inorganic compound in a solvating polymer, the thin layer being disposed on the first surface of the metallic film and having an average thickness of about 10 µm or less, the inorganic compound being present in the thin layer at a concentration of between about 40 wt.% and about 90 wt.%.

24. The electrode of claim 23, wherein the polymer is crosslinked.

25. The electrode of claim 23 or 24, wherein the inorganic compound is in the form of particles (e.g., spherical, rod-like, needle-like, etc.).

26. The electrode of claim 25, wherein the average particle size is less than 1 µm , less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or again between 50 nm and 200 nm, or between 100 nm and 200 nm, or between 1 nm and 100 nm, or between 10 nm and 100 nm, or again between 25 nm and 100 nm, or between 50 nm and 100 nm.

27. The electrode of claim 25 or 26, wherein the inorganic compound comprises a ceramic.

28. The electrode of any one of claims 25 to 27, wherein the inorganic compound is selected from Al₂O₃, Mg₂B₂O₅, Na₂O-2B₂O₃, xMgO·yB₂O₃·zH₂O, TiO₂, ZrO₂, ZnO, Ti₂Os, SiO₂, Cr₂O₃, CeO₂, B₂O₃, B₂O, SrBi₄Ti₄O₁₅, LLTO, LLZO, LAGP, LATP, Fe₂O₃, BaTiOs, γ-LiAlO₂, molecular sieves and zeolites (e.g., of aluminosilicate, of mesoporous silica), sulfide ceramics (such as Li₇P₃S₁₁), glass ceramics (such as LIPON, etc.), and other ceramics, as well as their combinations.

29. The electrode of any one of claims 25 to 28, wherein the inorganic compound particles further comprise organic groups covalently grafted to their surface, for example, said groups being selected from crosslinkable groups (such as organic groups comprising an acrylate function, a methacrylate function, a vinyl function, a glycidyl function, a mercapto function, etc.), aryl groups, alkylene oxide or poly(alkylene oxide) groups, and other organic groups.

30. The electrode of any one of claims 25 to 29, wherein the particles of the inorganic compound have a small specific surface area (e.g., less than 80 m²/g, or less than 40 m²/g).

31. The electrode of claim 30, wherein the inorganic compound is present in the thin layer at a concentration between about 65 wt.% and about 90 wt.%, or between about 70 wt.% and about 85 wt.%.

32. The electrode of any one of claims 25 to 29, wherein the particles of the inorganic compound have a large specific surface area (e.g., of 80 m²/g and above, or of 120 m²/g and above).

33. The electrode of claim 32, wherein the inorganic compound is present in the thin layer at a concentration between about 40 wt.% and about 65 wt.%, or between about 45 wt.% and about 55 wt.%.

34. The electrode of any one of claims 23 to 33, wherein the average thickness of the thin layer is between about 0.5 µm and about 10 µm, or between about 1 µm and about 10 µm, or between about 2 µm and about 8 µm, or between about 2 µm and about 7 µm, or between 2 µm and about 5 µm.

35. The electrode of any one of claims 23 to 34, wherein the solvating polymer is selected from linear or branched polyether polymers (e.g., PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, optionally comprising crosslinked units derived from crosslinkable functions (such as acrylate function, methacrylate function, vinyl function, glycidyl function, mercapto function, etc.).

36. The electrode of any one of claims 23 to 35, wherein the thin layer further comprises a lithium salt.

37. The electrode of claim 36, wherein the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)_{3]} (LiFAP), lithium tetrakis(trifluoroacetoxy)borate Li[B(OCOCF₃)_{4]} (LiTFAB), lithium bis(1,2-benzenediolato(2-)-O,O′)borate Li[B(CeO₂)_{2]} (LBBB), and a combination thereof.

38. The electrode of any one of claims 23 to 37, further comprising a current collector in contact with the second surface of the electrode material film.

39. The electrode of any one of claims 23 to 38, wherein the electrochemically active material is selected from metal phosphates, lithiated metal phosphates, metal oxides, and lithiated metal oxides.

40. The electrode of any one of claims 23 to 38, wherein the electrochemically active material is LiM’PO₄ where M′ is Fe, Ni, Mn, Co, or a combination thereof, LiV₃O₈, V₂O₅F, LiV₂O₅, LiMn₂O₄, LiM"O₂, where M″ is Mn, Co, Ni, or a combination thereof (such as NMC, LiMnₓCo_{y}Ni_{z}O₂ with x+y+z = 1), Li(NiM"')O₂ (where M‴ is Mn, Co, Al, Fe, Cr, Ti, Zr, or a combination thereof), elemental sulfur, elemental selenium, elemental iodine, iron(III) fluoride, copper(II) fluoride, lithium iodide, carbon-based active materials such as graphite, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-x1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other.

41. The electrode of any one of claims 23 to 40, wherein the electrochemically active material is in the form of optionally coated particles (e.g., with a polymer, ceramic, carbon or a combination of two or more thereof).

42. Electrode-electrolyte component comprising an electrode as herein defined in any one of claims 1 to 41, and a solid electrolyte.

43. The electrode-electrolyte component of claim 42, wherein the solid electrolyte comprises at least one solvating polymer and a lithium salt.

44. The electrode-electrolyte component of claim 43, wherein the solvating polymer of the electrolyte is selected from linear or branched polyether polymers (e.g., PEO, PPO, or an EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked.

45. The electrode-electrolyte component of claim 43 or 44, wherein the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)_{3]} (LiFAP), lithium tetrakis(trifluoroacetoxy)borate Li[B(OCOCF₃)_{4]} (LiTFAB), lithium bis(1 ,2-benzenediolato(2-)-O,O′)borate Li[B(CeO₂)_{2]} (LBBB), and a combination thereof.

46. The electrode-electrolyte component of any one of claims 42 to 45, wherein Ithe solid electrolyte comprises a ceramic.

47. Electrochemical cell comprising a negative electrode, a positive electrode, and a solid electrolyte, wherein the negative electrode is as defined in any one of claims 1 to 22.

48. Electrochemical cell comprising a negative electrode, a positive electrode, and a solid electrolyte, wherein the positive electrode is as defined in any one of claims 23 to 41.

49. Electrochemical cell comprising a negative electrode, a positive electrode, and a solid electrolyte, wherein the negative electrode is as defined in any one of claims 1 to 22 and the positive electrode is as defined in any one of claims 23 to 41.

50. Electrochemical cell of any one of claims 47 to 49, wherein the solid electrolyte comprises at least one solvating polymer and a lithium salt.

51. Electrochemical cell of claim 50, wherein the solvating polymer of the electrolyte is selected from linear or branched polyether polymers (e.g., PEO, PPO, or an EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked.

52. Electrochemical cell of claim 50 or 51, wherein the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)_{3]} (LiFAP), lithium tetrakis(trifluoroacetoxy)borate Li[B(OCOCF₃)_{4]} (LiTFAB), lithium bis(1,2-benzenediolato(2-)-O,O′)borate Li[B(CeO₂)_{2]} (LBBB), and a combination thereof.

53. Electrochemical cell of any one of claims 47 to 52, wherein the solid electrolyte further comprises a ceramic.

54. Electrochemical accumulator comprising at least one electrochemical cell as defined in any one of claims 47 to 53.

55. The electrochemical accumulator of claim 54, wherein said electrochemical accumulator is a lithium battery or a lithium-ion battery.

56. Use of an electrochemical accumulator of claim 54 or 55, in a portable device, in an electric or hybrid vehicle, or in renewable energy storage.

57. Use of claim 56, wherein the portable device is selected from cell phones, cameras, tablets, and laptops.
